(19) United States
(12) Patent Application Publication
(10) Pub. No.: US 2025/0381450 A1
(43) Pub. Date: Dec. 18, 2025

(54) GOLF BALL

(71) Applicant: Sumitomo Rubber Industries, Ltd., Kobe-shi (JP)

(72) Inventors: Kaita FUKAO, Kobe-shi (JP); Kosuke TACHIBANA, Kobe-shi (JP); Hidetaka INOUE, Kobe-shi (JP); Mami TANAKA, Kobe-shi (JP)

(73) Assignee: Sumitomo Rubber Industries, Ltd., Kobe-shi (JP)

(21) Appl. No.: 19/229,773

(22) Filed: Jun. 5, 2025

(30) Foreign Application Priority Data
Jun. 13, 2024 (JP) 2024-095964

(51) Int. Cl. A63B 37/00; C08G 18/44; C08G 18/48; C08G 18/73; C08G 18/79; C09D 175/04; C09D 175/08

(52) U.S. Cl. CPC A63B 37/00221; A63B 37/00222; A63B 37/0029; A63B 37/00621; A63B 37/0063; A63B 37/0074; A63B 37/0075; A63B 37/0087; C08G 18/44; C08G 18/4829; C08G 18/73; C08G 18/792; C09D 175/04; C09D 175/08

(57) ABSTRACT

An object of the present disclosure is to provide a golf ball that has an improved surface wear resistance and an improved stain resistance on bunker shots, has an improved shot feeling on long shots as well as a well-balanced total performance of a spin performance on approach shots and middle iron shots and a flight distance performance on driver shots. The present disclosure provides a golf ball comprising a spherical core, a cover and a paint film, wherein a center hardness (H₀) of the spherical core, each hardness (H₅, H₁₀, H₁₅) at 5, 10 or 15 mm point from a center of the spherical core, and a surface hardness (Hs) of the spherical core satisfy predetermined relationships, the cover is formed from a material having a loss modulus (E″₋₄₀) in a range from 6.50×10⁷ Pa to 22.0×10⁷ Pa and a loss modulus (E″₋₂₀) in a range from 3.50×10⁷ Pa to 7.10×10⁷ Pa, and the paint film is formed from a resin satisfying a relationship of 0.10≤ε1/M10≤1.00 wherein M10 (kgf/cm²) is a stress at which a strain is 10%, and ε1(%) is a strain at which a stress during deformation decreasing is 0 kgf/cm².

### FIELD OF THE DISCLOSURE

The present disclosure relates to a golf ball comprising a golf ball body composed of a spherical core, an intermediate layer and a cover, and a paint film formed on a surface of the golf ball body.

### DESCRIPTION OF THE RELATED ART

In order to get better scores in a golf match, a professional golfer or high-skilled golfer requires a golf ball to have excellent performance on all properties while keeping a good shot feeling. Specifically, a golf ball is required to have a high initial velocity and a low spin rate on driver shots from the viewpoint of improving the flight distance, and have a high spin rate on middle iron shots, short iron shots or approach shots (particularly under a condition that there is grass between the golf ball and the club face) from the viewpoint of controllability. For example, JP 2023-177977 A and JP 2023-174165 A disclose a golf ball having a good balance between the flight distance on driver shots and the spin performance on approach shots (particularly under a condition that there is grass between the golf ball and the club face) or middle iron shots by controlling a hardness distribution of a spherical core.

JP 2023-177977 A discloses a golf ball comprising a spherical core and a cover positioned outside the spherical core, wherein when H₀, H_{2.5}, H₅, H_{7.5}, H₁₀, H_{12.5}, H₁₅ and Hs are a center hardness of the spherical core (Shore C hardness), each hardness at 2.5 mm, 5 mm, 7.5 mm, 10 mm, 12.5 mm or 15 mm point from a center of the spherical core toward a surface of the spherical core (Shore C hardness), and a surface hardness of the spherical core (Shore C hardness), respectively, the following relationships are satisfied.

$$( {H}_{2.5} - {H}_{0} ) > ( {H}_{12.5} - {H}_{10} ) > ( Hs - {H}_{15} )$$

$$( {H}_{10} - {H}_{0} ) \geq 7 , and$$

$$0 \leq ( Hs - {H}_{15} ) \leq 5 .$$

JP 2023-174165 A discloses a golf ball comprising a spherical core and a cover covering the spherical core, wherein when a line extending from a center of the spherical core toward a surface of the spherical core is equally divided into eight segments, a center hardness (C0) of the spherical core, a hardness (C1) at a 12.5% point from the center, a hardness (C2) at a 25.0% point from the center, a hardness (C3) at a 37.5% point from the center, a hardness (C4) at a 50.0% point from the center, a hardness (C5) at a 62.5% point from the center, a hardness (C6) at a 75.0% point from the center, a hardness (C7) at an 87.5% point from the center and a surface hardness (C8) of the spherical core in Shore C hardness satisfy the following relationships.

$$0 < ( C 1 - C 0 ) \leq 6 \text{.0} ,$$

$$0 < ( C 2 - C 1 ) \leq 6 \text{.0} ,$$

$$0 < ( C 3 - C 2 ) \leq 6 \text{.0} ,$$

$$0 < ( C 4 - C 3 ) \leq 6 \text{.0} ,$$

$$5. \leq ( C 5 - C 4 ) ,$$

$$0 < ( C 6 - C 5 ) \leq 3 \text{.5} ,$$

$$0 < ( C 7 - C 6 ) \leq 3 \text{.5} ,$$

$$0 < ( C 8 - C 7 ) \leq 3.5 , and$$

$$1. \leq \{ ( C 5 - C 4 ) - ( C 4 - C 3 ) \} .$$

### SUMMARY OF THE DISCLOSURE

As mentioned above, a golf ball is required to have excellent performance on all properties while keeping a good shot feeling. However, with regard to the problem of balancing the flight distance on driver shots and the spin performance on approach shots (particularly under a condition that there is grass between the golf ball and the club face) or middle iron shots, there is still room for further improvement.

In addition, the wear or stain of the golf ball surface also affects the scores in the golf match, thus the golf ball is also required to have excellent wear resistance or stain resistance.

The present disclosure has been made in view of the above circumstances, and an object of the present disclosure is to provide a golf ball that has an improved surface wear resistance and an improved stain resistance on shots from the bunker, and has an improved shot feeling on long shots as well as a well-balanced total performance of a spin performance on approach shots from the rough (under a condition that there is grass between the golf ball and the club face), a spin performance on middle iron shots and a flight distance performance on driver shots.

The present disclosure that has solved the above problem provides a golf ball comprising a golf ball body composed of a spherical core and a cover covering the spherical core, and a paint film formed on a surface of the golf ball body, wherein a center hardness (H₀) of the spherical core, a hardness (H₅) at a point having a radial distance of 5.0 mm from a center of the spherical core, a hardness (H₁₀) at a point having a radial distance of 10 mm from the center of the spherical core, a hardness (H₁₅) at a point having a radial distance of 15 mm from the center of the spherical core, and a surface hardness (Hs) of the spherical core in Shore C hardness satisfy relationships of the following formulae (1) to (4), the cover is formed from a cover material having a loss modulus (E″₋₄₀) in a range from 6.50×10⁷ Pa to 22.0×10⁷ Pa at a measuring temperature of −40° C., and a loss modulus (E″₋₂₀) in a range from 3.50×10⁷ Pa to 7.10×10⁷ Pa at a measuring temperature of −20° C. measured with a dynamic viscoelasticity measurement apparatus, the paint film is formed from a paint resin satisfying a relationship of 0.10≤ε1/M10≤1.00, wherein a test piece formed from the paint resin is deformed until a strain of the test piece becomes a predetermined value εmax and then the deformation of the test piece is decreased until a stress of the test piece becomes 0 kgf/cm² in a tensile test, and M10 (kgf/cm²) is a stress at which a strain of the test piece is 10% during increase in the deformation, and ε1(%) is a strain at which a stress of the test piece is 0 kgf/cm² during decrease in the deformation.

$$- 3. \leq \{ ( {H}_{5} - {H}_{0} ) - ( {H}_{15} - {H}_{10} ) \} \leq 3. \qquad ( 1 )$$

$$- 3. \leq \{ ( {H}_{10} - {H}_{5} ) - ( {H}_{s} - {H}_{15} ) \} \leq 3. \qquad ( 2 )$$

$$5. \leq [ \{ ( {H}_{5} - {H}_{0} ) + ( {H}_{15} - {H}_{10} ) \} / 2 - \{ ( {H}_{10} - {H}_{5} ) + ( Hs - {H}_{15} ) \} / 2 ] \leq 10. \qquad ( 3 )$$

$$65 \leq \{ ( {H}_{5} + {H}_{10} + {H}_{15} ) / 3 \} \leq 73 \qquad ( 4 )$$

If the hardness distribution of the spherical core satisfies the formulae (1) to (3), the total performance of the flight distance on driver shots and the spin rate on middle iron shots and approach shots (particularly under a condition that there is grass between the golf ball and the club face) is well-balanced.

If the hardness distribution of the spherical core satisfies the formula (4), the shot feeling on long shots such as driver shots and iron shots is better. If the cover is formed from the specific cover material, the spin rate on driver shots decreases, and the spin rate on short iron shots increases.

If the paint film is formed from the specific paint resin, the spin rate on approach shots (particularly under a condition that there is grass between the golf ball and the club face) increases, and the wear resistance and stain resistance of the golf ball surface improve.

The golf ball according to the present disclosure is configured as above, and thus has improved surface wear resistance and stain resistance on bunker shots, and has an improved shot feeling on long shots as well as a well-balanced total performance of a spin performance on approach shots and middle iron shots and a flight distance performance on driver shots.

According to the present disclosure, a golf ball that has an improved surface wear resistance and an improved stain resistance on bunker shots, and has an improved shot feeling on long shots as well as a well-balanced total performance of a spin performance on approach shots and middle iron shots and a flight distance performance on driver shots, is obtained.

### BRIEF DESCRIPTION OF THE DRAWINGS

FIG. 1 is a graph illustrating a stress-strain curve of a golf ball paint resin obtained by a tensile test.

FIG. 2 is a partially cutaway cross-sectional view showing a golf ball according to one embodiment of the present disclosure;

FIG. 3 is a schematic cross-sectional view illustrating a measuring location of a thickness of a paint film; and

FIG. 4 is a schematic cross-sectional view illustrating a measuring location of a thickness of a paint film.

### DESCRIPTION OF THE PREFERRED EMBODIMENT

The golf ball according to the present disclosure comprises a golf ball body composed of a spherical core and a cover covering the spherical core, and a paint film formed on a surface of the golf ball body.

### (Spherical Core)

The golf ball body has a spherical core.

A center hardness (H₀) of the spherical core, a hardness (H₅) at a point having a radial distance of 5.0 mm from a center of the spherical core, a hardness (H₁₀) at a point having a radial distance of 10 mm from the center of the spherical core, a hardness (H₁₅) at a point having a radial distance of 15 mm from the center of the spherical core, and a surface hardness (Hs) of the spherical core in Shore C hardness satisfy relationships of the following formulae (1) to (3). The hardness distribution of the spherical core satisfy the relationships of the following formulae (1) to (4).

$$- 3. \leq \{ ( {H}_{5} - {H}_{0} ) - ( {H}_{15} - {H}_{10} ) \} \leq 3. \qquad ( 1 )$$

$$- 3. \leq \{ ( {H}_{10} - {H}_{5} ) - ( {H}_{s} - {H}_{15} ) \} \leq 3. \qquad ( 2 )$$

$$5. \leq [ \{ ( {H}_{5} - {H}_{0} ) + ( {H}_{15} - {H}_{10} ) \} / 2 - \{ ( {H}_{10} - {H}_{5} ) + ( Hs - {H}_{15} ) \} / 2 ] \leq 10. \qquad ( 3 )$$

$$65 \leq \{ ( {H}_{5} + {H}_{10} + {H}_{15} ) / 3 \} \leq 73 \qquad ( 4 )$$

The value {(H₅−H₀)−(H₁₅−H₁₀)} in the formula (1) is preferably −3.0 or more, more preferably −2.5 or more, and even more preferably −2.0 or more, and is preferably 3.0 or less in Shore C hardness.

The value {(H₁₀−H₅)−(Hₛ−H₁₅)} in the formula (2) is preferably −3.0 or more, more preferably −2.5 or more, and even more preferably −2.0 or more, and is preferably 3.0 or less, more preferably 2.5 or less, and even more preferably 2.0 or less in Shore C hardness.

The value [{(H₅−H₀)+(H₁₅−H₁₀)}/2−{(H₁₀−H₅)+(Hs−H₁₅)}/2] in the formula (3) is preferably 5.0 or more, more preferably 5.5 or more, and even more preferably 6.0 or more, and is preferably 10.0 or less, more preferably 9.5 or less, and even more preferably 9.0 or less in Shore C hardness. If the value [{(H₅−H₀)+(H₁₅−H₁₀)}/2−{(H₁₀−H₅)+(Hs−H₁₅)}/2] is 5.0 or more, the spin rate on driver shots is lowered, and if the value [{(H₅−H₀)+(H₁₅−H₁₀)}/2−{(H₁₀−H₅)+(Hs−H₁₅)}/2] is 10.0 or less, the golf ball has better impact durability.

If the hardness distribution of the spherical core satisfies the formulae (1) to (3), the ball initial velocity on driver shots is faster, and the spin rate on approach shots and middle iron shots increases.

The value {(H₅+H₁₀+H₁₅)/3} in the formula (4) is preferably 65 or more, more preferably 66 or more, and even more preferably 67 or more, and is preferably 73 or less in Shore C hardness. If the value {(H₅+H₁₀+H₁₅)/3} is 65 or more, the spin rate on driver shots is lowered, and if the value {(H₅+H₁₀+H₁₅)/3} is 73 or less, the shot feeling on long shots such as driver shots and iron shots is better.

The center hardness (H₀), the hardness (H₅), the hardness (H₁₀) and the hardness (H₁₅) in Shore C hardness preferably satisfy the relationship of the following formula (5).

$$[ \{ ( {H}_{5} - {H}_{0} ) + ( {H}_{15} - {H}_{10} ) \} / 2 ] \geq 6. \qquad ( 5 )$$

The value [{(H₅−H₀)+(H₁₅−H₁₀)}/2] in the formula (5) is preferably 6.0 or more, more preferably 6.5 or more, and even more preferably 7.0 or more, and is preferably 11.0 or less, more preferably 10.5 or less, and even more preferably 10.0 or less in Shore C hardness. If the value [{(H₅−H₀)+(H₁₅−H₁₀)}/2] is 6.0 or more, the spin rate on driver shots is lowered, and if the value [{(H₅−H₀)+(H₁₅−H₁₀)}/2] is 11.0 or less, the golf ball has better impact durability.

The hardness (H₅), the hardness (H₁₀), the hardness (H₁₅) and the surface hardness (Hs) in Shore C hardness preferably satisfy the relationship of the following formula (6).

$$[ \{ ( {H}_{10} - {H}_{5} ) + ( Hs - {H}_{15} ) \} / 2 ] \leq 2. \qquad ( 6 )$$

The value [{(H₁₀−H₅)+(Hs−H₁₅)}/2] in the formula (6) is preferably 0.0 or more, and is preferably 2.0 or less in Shore C hardness. If the value [{(H₁₀−H₅)+(Hs−H₁₅)}/2] is 0.0 or more and 2.0 or less, the ball initial velocity on driver shots is fast, and the spin rate on approach shots and middle iron shots increases.

The center hardness (H₀) and the surface hardness (Hs) in Shore C hardness preferably satisfy the relationship of the following formula (7).

$$( Hs - {H}_{0} ) \geq 18. \qquad ( 7 )$$

The value (Hs−H₀) in the formula (7) is preferably 18.0 or more, and is preferably 30.0 or less, more preferably 28.0 or less, and even more preferably 26.0 or less in Shore C hardness. If the value (Hs−H₀) is 18.0 or more, the spin rate on driver shots is lowered, and if the value (Hs−H₀) is 30.0 or less, the golf ball has better impact durability.

The center hardness (H₀) is preferably 57.0 or more, more preferably 57.5 or more, and even more preferably 58.0 or more, and is preferably 70.0 or less, more preferably 68.0 or less, and even more preferably 66.0 or less in Shore C hardness. If the center hardness (H₀) is 57.0 or more, the golf ball has better impact durability, and if the center hardness (H₀) is 70.0 or less, the spin rate on driver shots is lowered.

The surface hardness (Hs) is preferably 75.0 or more, more preferably 76.0 or more, and even more preferably 77.0 or more, and is preferably 88.0 or less, more preferably 87.0 or less, and even more preferably 86.0 or less in Shore C hardness. If the surface hardness (Hs) is 75.0 or more, the ball initial velocity on driver shots is fast, and if the surface hardness (Hs) is 88.0 or less, the golf ball has better impact durability.

The hardness (H₀), the hardness (H₅), the hardness (H₁₀), the hardness (H₁₅) and the hardness (Hs) preferably satisfy the relationship of the following formula (8).

$${H}_{0} < {H}_{5} < {H}_{10} < {H}_{15} < Hs \qquad ( 8 )$$

The hardness distribution of the spherical core can be controlled by adjusting the formulation of the rubber composition for forming the spherical core or the heating conditions for molding the spherical core.

The diameter of the spherical core is preferably 34.8 mm or more, more preferably 36.8 mm or more, and even more preferably 38.0 mm or more, and is preferably 42.2 mm or less, more preferably 41.8 mm or less, even more preferably 41.2 mm or less, and most preferably 40.8 mm or less.

When the spherical core has a diameter in the range from 34.8 mm to 42.2 mm, the compression deformation amount of the spherical core (shrinking amount of the spherical core along the compression direction) when applying a load from an initial load of 98 N to a final load of 1275 N to the spherical core is preferably 2.90 mm or more, more preferably 2.95 mm or more, and even more preferably 3.00 mm or more, and is preferably 3.70 mm or less, more preferably 3.65 mm or less, and even more preferably 3.60 mm or less. If the compression deformation amount falls within the above range, the shot feeling is better.

The construction of the spherical core may be a singled layered construction or a multiple layered construction composed of at least two layers, and is preferably the singled layered construction. Unlike the multiple layered spherical core, the single layered spherical core does not have an energy loss at the interface of the multiple layered spherical core when being hit, and thus has better resilience.

A conventionally known rubber composition (hereinafter sometimes simply referred to as “core rubber composition”) may be used for the spherical core. For example, the spherical core may be formed by heat pressing a rubber composition containing a base rubber, a co-crosslinking agent and a crosslinking initiator.

As the base rubber, a natural rubber and/or a synthetic rubber can be used. As the base rubber, for example, a polybutadiene rubber, a natural rubber, a polyisoprene rubber, a styrene-butadiene rubber, or an ethylene-propylene-diene rubber (EPDM) can be used. These rubbers may be used solely, or at least two of them may be used in combination. As the base rubber, particularly preferred is a high-cis polybutadiene having a cis bond in an amount of 40 mass % or more, preferably 70 mass % or more, and more preferably 90 mass % or more in view of its superior resilience.

As the co-crosslinking agent, an α,β-unsaturated carboxylic acid having 3 to 8 carbon atoms or a metal salt thereof is preferable, and acrylic acid or a metal salt thereof, and methacrylic acid or a metal salt thereof are more preferable. As the metal constituting the metal salt, zinc, magnesium, calcium, aluminum or sodium is preferable, and zinc is more preferable. The amount of the co-crosslinking agent is preferably 20 parts by mass or more and 50 parts by mass or less with respect to 100 parts by mass of the base rubber. In a case that the α,β-unsaturated carboxylic acid having 3 to 8 carbon atoms is used as the co-crosslinking agent, a metal compound (e.g. magnesium oxide) is preferably added.

As the crosslinking initiator, an organic peroxide is preferably used. Specific examples of the organic peroxide include dicumyl peroxide, 1,1-bis(t-butylperoxy)-3,3,5-trimethylcyclohexane, 2,5-dimethyl-2,5-di(t-butylperoxy) hexane, and di-t-butyl peroxide. Among them, dicumyl peroxide is preferably used. The amount of the crosslinking initiator is preferably 0.2 part by mass or more, more preferably 0.3 part by mass or more, and even more preferably 0.4 part by mass or more, and is preferably 5 parts by mass or less, more preferably 4 parts by mass or less, and even more preferably 3 parts by mass or less with respect to 100 parts by mass of the base rubber.

The core rubber composition may further contain a monophenol compound having a substituent only at a p-position. The monophenol compound having the substituent only at the p-position is a compound having a substituent directly bonded to a p-position relative to one hydroxy group of a phenol, and has no substituent at an o-position and m-position of the hydroxy group. Examples of the substituent at the p-position include an alkoxy group, a halogen group, a hydrocarbon group, a nitro group, a cyano group, an amino group and a hydroxy group, and the alkoxy group is preferable. Examples of the monophenol compound having the substituent only at the p-position include 4-methoxyphenol. The amount of the monophenol compound having the substituent only at the p-position is preferably 0.05 part by mass or more, more preferably 0.07 part by mass or more, and even more preferably 0.10 part by mass or more, and is preferably 2.0 parts by mass or less, more preferably 1.8 parts by mass or less, and even more preferably 1.6 parts by mass or less with respect to 100 parts by mass of the base rubber.

The core rubber composition may further contain an organic sulfur compound. As the organic sulfur compound, diphenyl disulfides (diphenyl disulfide, bis (pentabromophenyl) disulfide, etc.), thiophenols, or thionaphthols can be suitably used. The amount of the organic sulfur compound is preferably 0.1 part by mass or more, more preferably 0.2 part by mass or more, and even more preferably 0.3 part by mass or more, and is preferably 5.0 parts by mass or less, more preferably 4.0 parts by mass or less, and even more preferably 2.0 parts by mass or less with respect to 100 parts by mass of the base rubber.

The core rubber composition may further contain a carboxylic acid and/or a salt thereof. As the carboxylic acid and/or the salt thereof, a carboxylic acid having 1 to 30 carbon atoms and/or a salt thereof is preferable. As the carboxylic acid, any one of an aliphatic carboxylic acid and an aromatic carboxylic acid (such as benzoic acid) may be used. The amount of the carboxylic acid and/or the salt thereof is preferably 1 part by mass or more and 40 parts by mass or less with respect to 100 parts by mass of the base rubber.

The core rubber composition may further appropriately contain a weight adjusting agent such as zinc oxide and barium sulfate, an antioxidant, a colored powder, or the like, in addition to the base rubber, the co-crosslinking agent, the crosslinking initiator, and the organic sulfur compound.

The core rubber composition can be prepared by mixing and kneading the raw materials. The kneading method is not particularly limited. For example, the kneading can be conducted with a conventional kneading machine such as a kneading roll, a banbury mixer and a kneader.

The heat pressing condition for molding the core rubber composition can be suitably set according to the rubber formulation, and examples thereof include an embodiment of heating the core rubber composition at a temperature of 150° C. to 170° C. for 15 minutes to 20 minutes, and a two-step heating embodiment of heating the core rubber composition at a temperature of 140° C. to 150° C. for 8 minutes to 12 minutes followed by heating the core rubber composition at a temperature of 150° C. to 160° C. for 10 minutes to 15 minutes.

### (Intermediate Layer)

The golf ball body may have an intermediate layer covering the spherical core. The intermediate layer may have one layer or at least two layers, and preferably has one layer.

The thickness of the intermediate layer is preferably 0.70 mm or more, more preferably 0.75 mm or more, and even more preferably 0.80 mm or more, and is preferably less than 1.30 mm, more preferably 1.25 mm or less, and even more preferably 1.20 mm or less. If the thickness of the intermediate layer is 0.70 mm or more, the productivity and impact durability of the golf ball are better, and if the thickness of the intermediate layer is less than 1.30 mm, the spin rate on middle iron shots increases. It is noted that in the case of comprising a plurality of intermediate layers, the total thickness of all the intermediate layers is defined as the thickness of the intermediate layer.

Examples of the resin component used for the intermediate layer composition for forming the intermediate layer include a thermoplastic resin such as polyurethane resin, an ionomer resin, a polyamide resin and a polyethylene; and a thermoplastic elastomer such as a styrene elastomer, a polyolefin elastomer, a polyurethane elastomer, a polyamide elastomer and a polyester elastomer. Herein, examples of the ionomer resin include a product obtained by neutralizing, with a metal ion, at least a part of carboxyl groups in a copolymer composed of ethylene and an α,β-unsaturated carboxylic acid; and a product obtained by neutralizing, with a metal ion, at least a part of carboxyl groups in a terpolymer composed of ethylene, an α,β-unsaturated carboxylic acid and an α,β-unsaturated carboxylic acid ester. The intermediate layer composition may further contain a weight adjusting agent such as barium sulfate and tungsten, an antioxidant, a pigment (titanium dioxide, etc.), and the like.

The slab hardness of the intermediate layer composition constituting the intermediate layer is preferably 60 or more, more preferably 62 or more, and even more preferably 63 or more, and is preferably 75 or less, more preferably 74 or less, and even more preferably 73 or less in Shore D hardness. If the slab hardness is 60 or more in Shore D hardness, the flight distance performance even on long iron shots is even better, and if the slab hardness is 75 or less in Shore D hardness, the feeling on shots is even better.

### (Cover)

The golf ball body has a cover covering the spherical core. It is noted that the cover covers the intermediate layer in a case that the golf ball body has the intermediate layer covering the spherical core. The cover is a layer formed on the outermost surface of the golf ball body.

The cover is formed from a cover material having a loss modulus (E″₋₄₀) in a range from 6.50×10⁷ Pa to 22.0×10⁷ Pa at a measuring temperature of −40° C., and a loss modulus (E″₋₂₀) in a range from 3.50×10⁷ Pa to 7.10×10⁷ Pa at a measuring temperature of −20° C., measured with a dynamic viscoelasticity measurement apparatus under the following measuring conditions:

### <Measuring Conditions of Dynamic Viscoelasticity Measurement Apparatus>

measuring mode: tensile mode
measuring temperature: −100° C. to 100° C.
temperature rising rate: 4° C./min
oscillation frequency: 10 Hz
measuring strain: 0.05%
   The loss modulus is sometimes referred to as loss elastic modulus.

The loss modulus (E″₋₄₀) at the measuring temperature of −40° C. is a physical property affecting the spin rate on driver shots. The spin rate on driver shots can be lowered by controlling the loss modulus (E″₋₄₀).

The loss modulus (E″₋₄₀) is preferably 6.50×10⁷ Pa or more, more preferably 6.60×10⁷ Pa or more, and even more preferably 6.70×10⁷ Pa or more, and is preferably 22.0×10⁷ Pa or less, more preferably 21.0×10⁷ Pa or less, and even more preferably 20.0×10⁷ Pa or less. If the loss modulus (E″₋₄₀) is 6.50×10⁷ Pa or more, the spin rate on driver shots is lowered, and if the loss modulus (E″₋₄₀) is 22.0×10⁷ Pa or less, the handling during the production is easier.

The loss modulus (E″₋₂₀) at the measuring temperature of −20° C. is a physical property affecting the spin rate on short iron shots. The spin rate on short iron shots can be increased by controlling the loss modulus (E″₋₂₀). The loss modulus (E″₋₂₀) is preferably 3.50×10⁷ Pa or more, more preferably 3.60×10⁷ Pa or more, and even more preferably 3.70×10⁷ Pa or more, and is preferably 7.10×10⁷ Pa or less, more preferably 7.00×10⁷ Pa or less, and even more preferably 6.90×10⁷ Pa or less. If the loss modulus (E″₋₂₀) is 3.50×10⁷ Pa or more, the spin rate on iron shots increases, and if the loss modulus (E″₋₂₀) is 7.10×10⁷ Pa or less, lowering in the ball initial velocity on driver shots is inhibited.

The slab hardness of the golf ball cover material is preferably 65 or more, more preferably 68 or more, and even more preferably 70 or more, and is preferably 95 or less, more preferably 93 or less, and even more preferably 92 or less in Shore A hardness. If the slab hardness is 65 or more in Shore A hardness, the handling during the production is easier, and if the slab hardness is 95 or less in Shore A hardness, a higher level of the spin rate can be kept on approach shots.

The golf ball cover material preferably contains, as a resin component, a polyurethane for the cover obtained by a reaction between a polyol and a polyisocyanate.

The polyol is a compound having two or more hydroxy groups in the molecule. The polyol may be used solely, or at least two polyols may be used in combination.

As the polyol constituting the polyurethane for the cover, a polyol having a number average molecular weight of 200 or more and 6000 or less is preferably used. The polyol having the number average molecular weight of 200 or more and 6000 or less forms a soft segment and imparts softness to the polyurethane.

The number average molecular weight of the polyol constituting the polyurethane for the cover is preferably 200 or more, more preferably 300 or more, and even more preferably 1000 or more, and is preferably 6000 or less, more preferably 4000 or less, and even more preferably 3000 or less.

As the polyol constituting the polyurethane for the cover, at least one polymer polyol selected from the group consisting of a polyether polyol, a condensed polyester polyol, a lactone polyester polyol, a polycarbonate polyol and an acrylic polyol is preferable. The polymer polyol is a polymer obtained by polymerizing a low molecular compound, and has a plurality of hydroxyl groups. The polymer polyol may be derived from petroleum resources or biomass resources.

Examples of the polyether polyol include polyoxyethylene glycol (PEG), polyoxypropylene glycol (PPG), polytrimethylene ether glycol (PO3G), and polytetramethylene ether glycol (PTMG).

Examples of the condensed polyester polyol include polyethylene adipate (PEA), polybutylene adipate (PBA), and polyhexamethylene adipate (PHMA).

Examples of the lactone polyester polyol include poly-ε-caprolactone (PCL).

Examples of the polycarbonate polyol include polyhexamethylene carbonate.

The polymer polyol is preferably a polymer diol having two hydroxy groups. Use of the polymer diol provides a linear thermoplastic polyurethane and facilitates the molding of the polyurethane into the constituent member of the golf ball.

As the polyol constituting the polyurethane for the cover, the polyether polyol is preferable. Particularly, the amount of the polyether polyol is preferably 50 mass % or more, more preferably 55 mass % or more, and even more preferably 60 mass % or more in 100 mass % of the polyol constituting the polyurethane for the cover. If the amount of the polyether polyol is 50 mass % or more, the mechanical strength can be maintained for a long time. It is noted that when the golf ball cover material contains two or more polyurethanes for the cover, the amount of the polyether polyol in 100 mass % of the polyol constituting each of the polyurethanes for the cover preferably falls within the above range.

The polyol constituting the polyurethane for the cover preferably includes a first polymer polyol and a second polymer polyol having a number average molecular weight greater than the first polymer polyol. If the polyol includes the first polymer polyol and the second polymer polyol, the spin rate on iron shots can be further increased.

It is noted that examples of the embodiment that the polyol constituting the polyurethane for the cover includes the first polymer polyol and the second polymer polyol include an embodiment in which the first polymer polyol and the second polymer polyol are included as the polyol that is the constituent component of one polyurethane; and an embodiment in which a first polyurethane including the first polymer polyol as the polyol that is the constituent component, and a second polyurethane including the second polymer polyol as the polyol that is the constituent component are used in combination.

When the polyol constituting the polyurethane for the cover includes the first polymer polyol and the second polymer polyol, the difference (Mm2−Mm1) between the number average molecular weight (Mm2) of the second polymer polyol and the number average molecular weight (Mm1) of the first polymer polyol is preferably 50 or more, more preferably 100 or more, and even more preferably 200 or more, and is preferably 1500 or less, more preferably 1200 or less, and even more preferably 1000 or less.

The number average molecular weight (Mm1) of the first polymer polyol is preferably 200 or more, more preferably 500 or more, and even more preferably 800 or more, and is preferably 3000 or less, more preferably 2000 or less, and even more preferably 1500 or less.

The number average molecular weight (Mm2) of the second polymer polyol is preferably 1000 or more, more preferably 1200 or more, and even more preferably 1400 or more, and is preferably 6000 or less, more preferably 4500 or less, and even more preferably 3000 or less.

The polyisocyanate constituting the polyurethane for the cover is not particularly limited, as long as the polyisocyanate has two or more isocyanate groups. The polyisocyanate may be used solely, or at least two polyisocyanates may be used in combination.

Examples of the polyisocyanate include an aromatic polyisocyanate, an alicyclic polyisocyanate, and an aliphatic polyisocyanate.

Examples of the aromatic polyisocyanate include 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and para-phenylene diisocyanate (PPDI).

Examples of the alicyclic polyisocyanate and the aliphatic polyisocyanate include 4,4′-dicyclohexylmethane diisocyanate (H₁₂MDI), hydrogenated xylylenediisocyanate (H₆XDI), hexamethylene diisocyanate (HDI), isophorone diisocyanate (IPDI), and norbornene diisocyanate (NBDI).

As the polyisocyanate constituting the polyurethane for the cover, the aromatic polyisocyanate is preferably used from the viewpoint of improving the abrasion resistance. If the aromatic polyisocyanate is used, the obtained polyurethane has enhanced mechanical properties, and the obtained cover has excellent abrasion resistance.

In addition, as the polyisocyanate constituting the polyurethane, the non-yellowing polyisocyanate (TMXDI, XDI, HDI, H₆XDI, IPDI, H₁₂MDI, NBDI, etc.) is preferably used, and 4,4′-dicyclohexylmethane diisocyanate (H₁₂MDI) is more preferably used, from the viewpoint of improving the weather resistance. The 4,4′-dicyclohexylmethane diisocyanate (H₁₂MDI) has a rigid structure, thus the obtained polyurethane has enhanced weather resistance and enhanced mechanical properties, and a cover also having excellent abrasion resistance is obtained.

The polyurethane for the cover may further have a chain extender as a constituent component, as long as the chain extender does not impair the effect of the preset disclosure. As the chain extender component, a low molecular weight polyol, a low molecular weight polyamine, or the like can be used.

Examples of the low molecular weight polyol include a diol such as ethylene glycol, diethylene glycol, triethylene glycol, propane diol (e.g. 1,2-propane diol, 1,3-propane diol, 2-methyl-1,3-propane diol), dipropylene glycol, butane diol (e.g. 1,2-butane diol, 1,3-butane diol, 1,4-butane diol, 2,3-butane diol, 2,3-dimethyl-2,3-butane diol), neopentyl glycol, pentane diol, hexane diol, heptane diol, octane diol, and 1,4-cyclohexane dimethylol; a triol such as glycerin, trimethylolpropane, and hexane triol; and a tetraol or hexaol such as pentaerythritol, and sorbitol.

In addition, the low molecular weight polyamine that can be used as the chain extender component is not particularly limited, as long as it has at least two amino groups.

Examples of the polyamine include an aliphatic polyamine such as ethylene diamine, propylene diamine, butylene diamine, and hexamethylene diamine; an alicyclic polyamine such as isophorone diamine and piperazine; and an aromatic polyamine.

The aromatic polyamine is not particularly limited, as long as it has at least two amino groups directly or indirectly bonded to an aromatic ring. Herein, the “indirectly bonded” means that the amino group is bonded to the aromatic ring via, for example, a lower alkylene group.

The aromatic polyamine may be, for example, a monocyclic aromatic polyamine having at least two amino groups bonded to one aromatic ring, or a polycyclic aromatic polyamine having at least two aminophenyl groups each having at least one amino group bonded to one aromatic ring.

Examples of the monocyclic aromatic polyamine include a type having the amino groups directly bonded to the aromatic ring, such as phenylene diamine, toluene diamine, diethyltoluene diamine, and dimethylthiotoluene diamine; and a type having the amino groups bonded to the aromatic ring via the lower alkylene group, such as xylylene diamine.

In addition, the polycyclic aromatic polyamine may be a poly(aminobenzene) having at least two aminophenyl groups directly bonded to each other, or a compound having at least two aminophenyl groups bonded to each other via a lower alkylene group or an alkylene oxide group. Among them, a diaminodiphenyl alkane having two aminophenyl groups bonded to each other via a lower alkylene group is preferable. Particularly, 4,4′-diaminodiphenyl methane or the derivative thereof is preferable.

The molecular weight of the chain extender is preferably 400 or less, more preferably 350 or less, and even more preferably less than 200, and is preferably 30 or more, more preferably 40 or more, and even more preferably 45 or more. It is noted that the “low molecular weight polyol” and “low molecular weight polyamine” used as the chain extender are low molecular compounds which do not have a molecular weight distribution, and are distinguished from the polymer polyol having the number average molecular weight of 200 or more and 3000 or less obtained by polymerizing the low molecular compound.

The constitutional embodiment of the polyurethane for the cover is not particularly limited, and examples thereof include an embodiment where the polyurethane is composed of the polyisocyanate, and the polyol having the number average molecular weight of 200 or more and 6000 or less; an embodiment where the polyurethane is composed of the polyisocyanate, the polyol having the number average molecular weight of 200 or more and 6000 or less, and the chain extender; and an embodiment where the polyurethane is composed of the polyisocyanate, the first polymer polyol having the number average molecular weight of 200 or more and 3000 or less, the second polymer polyol having the number average molecular weight that is 1000 or more and 6000 or less and greater than the first polymer polyol, and the chain extender component.

The polyurethane for the cover may be either a thermoplastic polyurethane or a thermosetting polyurethane. The thermoplastic polyurethane is a polyurethane exhibiting plasticity by heating and generally means a polyurethane having a linear chain structure of a high-molecular weight to a certain extent. The thermosetting polyurethane is a polyurethane obtained for use through a curing reaction between a prepolymer having a relatively low molecular weight and a curing agent. A three-dimensional crosslinked structure is formed in the thermosetting polyurethane by controlling the number of the functional group of the prepolymer or the curing agent to be used. The polyurethane is preferably the thermoplastic polyurethane. If the polyurethane is the thermoplastic polyurethane, the cover is easily molded.

Examples of the synthesis method of the polyurethane for the cover include a one-shot method and a prepolymer method. The one-shot method is a method of proceeding a reaction of a polyisocyanate, a polyol, or the like at once. The prepolymer method is a method of proceeding a reaction of a polyisocyanate, a polyol, or the like in multiple steps, for example, a method of synthesizing a urethane prepolymer having a relatively low molecular weight followed by further polymerizing the urethane prepolymer.

Next, as an example of producing the polyurethane by the prepolymer method, an embodiment in which an isocyanate group terminated urethane prepolymer is synthesized and then the isocyanate group terminated urethane prepolymer is polymerized using the chain extender will be described in detail.

First, a reaction between the polyisocyanate and the polymer polyol is conducted to synthesize the isocyanate group terminated urethane prepolymer. In this case, the charging ratio of the polyisocyanate to the polymer polyol is preferably 1.0 or more, more preferably 1.2 or more, and even more preferably 1.5 or more, and is preferably 10 or less, more preferably 9 or less, and even more preferably 8 or less in a molar ratio (NCO/OH) of the isocyanate group (NCO) included in the polyisocyanate to the hydroxy group (OH) included in the polymer polyol.

The temperature at which the prepolymer reaction is conducted is preferably 10° C. or more, more preferably 30° C. or more, and even more preferably 50° C. or more, and is preferably 200° C. or less, more preferably 150° C. or less, and even more preferably 100° C. or less.

In addition, the reaction time is preferably 10 minutes or more, more preferably 1 hour or more, and even more preferably 3 hours or more, and is preferably 32 hours or less, more preferably 16 hours or less, and even more preferably 8 hours or less.

Next, the obtained isocyanate group terminated urethane prepolymer is subjected to a chain extension reaction with the chain extender to obtain the high molecular weight polyurethane. In this case, the charging ratio of the isocyanate group terminated urethane prepolymer to the chain extender is preferably 0.9 or more, more preferably 0.92 or more, and even more preferably 0.95 or more, and is preferably 1.1 or less, more preferably 1.08 or less, and even more preferably 1.05 or less in a molar ratio (NCO/OH) of the isocyanate group (NCO) included in the isocyanate group terminated urethane prepolymer to the hydroxy group (OH) of the chain extender.

The temperature at which the chain extension reaction is conducted is preferably 10° C. or more, more preferably 30° C. or more, and even more preferably 50° C. or more, and is preferably 220° C. or less, more preferably 170° C. or less, and even more preferably 120° C. or less.

In addition, the reaction time is preferably 10 minutes or more, more preferably 30 minutes or more, and even more preferably 1 hour or more, and is preferably 20 days or less, more preferably 10 days or less, and even more preferably 5 days or less.

Each of the prepolymer reaction and the chain extension reaction is preferably conducted in an atmosphere of dry nitrogen.

A conventionally known catalyst can be used for the synthesis of the polyurethane for the cover. Examples of the catalyst include a monoamine such as triethyl amine and N,N-dimethylcyclohexylamine; a polyamine such as N,N,N′,N′-tetramethylethylene diamine and N,N,N′,N″,N″-pentamethyldiethylene triamine; a cyclic diamine such as 1,8-diazabicyclo[5.4.0]-7-undecene (DBU) and triethylene diamine; a tin catalyst such as dibutyl tin dilaurate and dibutyl tin diacetate. These catalysts may be used solely, or two or more of the catalysts may be used in combination. Among them, the tin catalyst such as dibutyl tin dilaurate and dibutyl tin diacetate is preferred, and in particular, dibutyl tin dilaurate is preferably used.

The amount of the polyurethane for the cover is preferably 50 mass % or more, more preferably 70 mass % or more, and even more preferably 90 mass % or more in 100 mass % of the resin component of the golf ball cover material. The resin component may consist of the polyurethane for the cover.

The golf ball cover material may contain one polyurethane for the cover as the resin component, or may contain two or more polyurethanes for the cover as the resin component. The golf ball cover material preferably contains the first polyurethane for the cover including the first polymer polyol as the constituent component and the second polyurethane for the cover including the second polymer polyol as the constituent component.

When the golf ball cover material contains the first polyurethane for the cover and the second polyurethane for the cover as the resin component, their mass ratio (the first polyurethane for the cover/the second polyurethane for the cover) is preferably 1/99 or more, more preferably 30/70 or more, and even more preferably 50/50 or more, and is preferably 99/1 or less, more preferably 98/2 or less, and even more preferably 95/5 or less.

The golf ball cover material preferably contains only the polyurethane for the cover as the resin composition, but may further contain other resin components, as long as the other resin components don't impair the effect of the present disclosure.

Examples of the other resin components include an ionomer resin and a thermoplastic elastomer.

Examples of the ionomer resin include a product obtained by neutralizing at least a part of carboxyl groups in a copolymer composed of ethylene and an α,β-unsaturated carboxylic acid having 3 to 8 carbon atoms with a metal ion; a product obtained by neutralizing at least a part of carboxyl groups in a terpolymer composed of ethylene, an α,β-unsaturated carboxylic acid having 3 to 8 carbon atoms and an α,β-unsaturated carboxylic acid ester with a metal ion; and a mixture of those. Specific examples of the ionomer resin include “Himilan (registered trademark)” available from Dow-Mitsui Polychemicals Co., Ltd., “Surlyn (registered trademark)” available from E.I. du Pont de Nemours and Company, and “Iotek (registered trademark)” available from ExxonMobil Chemical Corporation.

Specific examples of the thermoplastic elastomer include a thermoplastic polyurethane elastomer such as “Elastollan (registered trademark) (e.g. “Elastollan XNY88A”)” available from BASF Japan Ltd.; a thermoplastic polyamide elastomer such as “Pebax (registered trademark) (e.g. “Pebax 2533”)” available from Arkema K. K.; a thermoplastic polyester elastomer such as “Hytrel (registered trademark) (e.g. “Hytrel 3548” and “Hytrel 4047”)” available from Du Pont-Toray Co., Ltd.; and a thermoplastic polystyrene elastomer such as “TEFABLOC (registered trademark)” available from Mitsubishi Chemical Corporation.

The golf ball cover material may further contain a pigment component such as titanium oxide and a blue pigment, a weight adjusting agent such as calcium carbonate and barium sulfate, a dispersant, an antioxidant, an ultraviolet absorber, a light stabilizer, a fluorescent material or fluorescent brightener, or the like, as long as they do not impair the performance of the cover.

The amount of the white pigment (e.g. titanium oxide) is preferably 0.5 part by mass or more, more preferably 1 part by mass or more, and even more preferably 1.5 parts by mass or more, and is preferably 10 parts by mass or less, more preferably 8 parts by mass or less, and even more preferably 6 parts by mass or less, with respect to 100 parts by mass of the resin component. If the amount of the white pigment is 0.5 part by mass or more, it is possible to impart the opacity to the golf ball material, and if the amount of the white pigment is 10 parts by mass or less, lowering in the durability of the golf ball material can be suppressed.

The method for molding the cover from the cover material is not particularly limited, and examples thereof include a method of injection molding the cover material directly onto the spherical core; and a method of molding the cover material into hollow shells, covering the spherical core with a plurality of the hollow shells and compression molding the spherical core with a plurality of the hollow shells (preferably a method of molding the cover material into half hollow-shells, covering the spherical core with two of the half hollow-shells and compression molding the spherical core with two of the half hollow-shells). After the cover is molded, the obtained golf ball body is ejected from the mold, and as necessary, the golf ball body is preferably subjected to surface treatments such as deburring, cleaning, and sandblast. If desired, a mark may be formed.

The thickness of the cover is preferably 0.3 mm or more, more preferably 0.4 mm or more, and even more preferably 0.5 mm or more, and is preferably 2.0 mm or less, more preferably 1.5 mm or less, and even more preferably 1.0 mm or less. If the thickness of the cover is 0.3 mm or more, the cover is more easily molded, and if the thickness of the cover is 2.0 mm or less, the core has a relatively large diameter and thus the golf ball has enhanced resilience performance.

The total number of dimples formed on the cover is preferably 200 or more and 500 or less. If the total number is less than 200, the dimple effect is hardly obtained. On the other hand, if the total number exceeds 500, the dimple effect is hardly obtained because the size of the respective dimples is small. The shape (shape in a plan view) of dimples includes, for example, without limitation, a circle, a polygonal shape such as a roughly triangular shape, a roughly quadrangular shape, a roughly pentagonal shape, a roughly hexagonal shape, and other irregular shapes. The shape of dimples is employed solely or at least two of them may be used in combination.

### (Paint Film)

The golf ball has a paint film formed on the surface of the golf ball body.

The paint film is formed from a paint resin satisfying a relationship of 0.10≤ε1/M10≤1.00, wherein a test piece formed from the paint resin is deformed until a strain of the test piece becomes a predetermined value εmax and then the deformation of the test piece is decreased until a stress of the test piece becomes 0 kgf/cm² in a tensile test, and M10 (kgf/cm²) is a stress at which a strain of the test piece is 10% during increase in the deformation, and ε1(%) is a strain at which a stress of the test piece is 0 kgf/cm² during decrease in the deformation.

### <Test Conditions of Tensile Test>

dimension of test piece: width of 4 mm and thickness of 100 μm±10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%).

If the resin satisfying the above specific relationship in the stress-strain curve obtained by the tensile test is used as the paint resin, the golf ball has improved spin performance on approach shots (particularly improved spin performance on approach shots from the rough), excellent wear resistance of a golf ball surface, and excellent stain resistance on shots from the bunker. The reason why the golf ball has improved spin performance on approach shots, excellent wear resistance of a golf ball surface and excellent stain resistance on shots from the bunker, is not clear, but it is considered that the paint film of the golf ball according to the present disclosure has a strong power to return to the original state even if it deforms on bunker shots, thus the stain such as sand, soil or grass juice hardly enters into the paint film, and the stain is easily removed even if the surface of the paint film is stained.

Next, the tensile test method for the golf ball paint resin will be explained.

As the test piece for the tensile test, a strip-shaped test piece having a dimension with a width of 4 mm, a length of 20 mm or more, and a thickness of 100 μm±10 μm is prepared. It is noted that the length of the test piece is not particularly limited, as long as the test piece has a length such that the distance between clamps when conducting the tensile test is 20 mm, but the length of the test piece is more preferably 25 mm or more and 35 mm or less.

The tensile tester is not particularly limited, and a dynamic viscoelasticity measuring apparatus is preferably used. Examples of the dynamic viscoelasticity measuring apparatus include Rheogel-E4000 available from UBM CO., Ltd.

The tensile test is conducted according to the following procedure.

1) The strip-shaped test piece is gripped with the clamps, and the clamps are moved in a direction of increasing the deformation of the test piece to elongate the test piece until the strain of the test piece becomes the predetermined value εmax. The distance between the clamps is 20 mm. The tensile speed during increase in the deformation is 1.1 mm/second. The stress M10 (kgf/cm²) at which the strain of the test piece is 10% during increase in the deformation, and the stress M50 (kgf/cm²) at which the strain of the test piece is the predetermined value εmax (εmax=50%) during increase in the deformation are recorded respectively.

2) When the strain of the test piece reaches the predetermined value εmax, the clamps are immediately returned in a direction of decreasing the deformation of the test piece. The returning speed during decrease in the deformation is 1.1 mm/second.

3) The strain ε1 at which the stress applied to the test piece becomes 0 is recorded.

4) The temperature of the tensile test is 23° C., and the data acquisition points per second are 50.

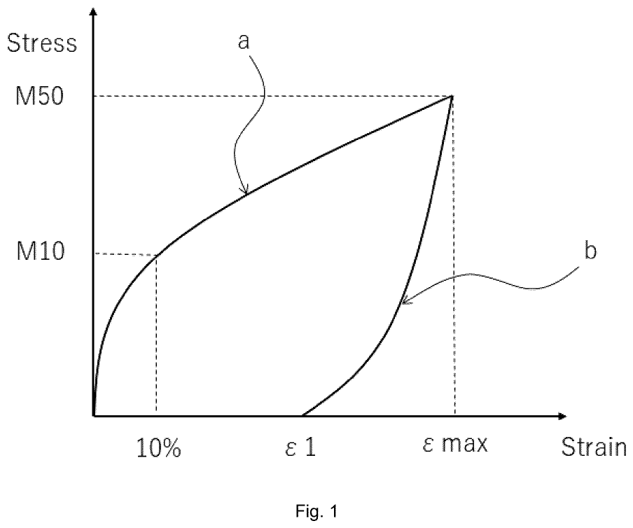

FIG. 1 is a schematic graph of one example of a stress-strain curve obtained by the tensile test of the present disclosure. The curve “a” is a stress-strain curve obtained by moving the clamps in the direction of increasing the deformation of the test piece to elongate the test piece until the strain of the test piece becomes the predetermined value εmax (i.e. obtained during increase in the deformation). In the present disclosure, M10 is the stress at which the strain is 10%, and M50 is the stress at which the strain is the predetermined value εmax (εmax=50%) in the curve “a”. The curve “b” is a stress-strain curve obtained by moving the clamps in the direction of decreasing the deformation of the test piece after the strain of the test piece reaches the predetermined value εmax (i.e. obtained during decrease in the deformation). At the intersection of the curve “b” with the X-axis, the stress applied to the test piece is 0. In the present disclosure, the strain at this intersection is ε1. It is noted that ε1 is shown to be greater than 10% (ε1>10%) in FIG. 1, but ε1 can also be equal to 10% (ε1=10%) or lower than ε1 (ε1<10%).

In the present disclosure, the strain ε is represented by the following formula.

$$Strain ε ( \% ) = 100 \times Δ L / L$$

In the formula, L is the distance between the clamps (i.e. the length of the test piece between the clamps) before applying a load to the test piece, and ΔL is the displacement amount during the deformation.

In the tensile test of the present disclosure, the test piece is elongated in the direction of increasing the deformation of the test piece until the strain of the test piece becomes the predetermined value εmax (εmax=50%), and when the strain of the test piece reaches the predetermined value εmax (εmax=50%) the clamps are returned in the direction of decreasing the deformation of the test piece.

The golf ball paint resin preferably satisfies the relationship of 0.10≤ε1/M10≤1.00, wherein the test piece formed from the golf ball paint resin is deformed until the strain of the test piece becomes the predetermined value εmax (εmax=50%) and then the deformation of the test piece is decreased until the stress of the test piece becomes 0 kgf/cm² in the tensile test, and M10 (kgf/cm²) is the stress at which the strain of the test piece is 10% during increase in the deformation, and ε1(%) is the strain at which the stress of the test piece is 0 kgf/cm² during decrease in the deformation. The ε1/M10 is preferably 0.20 or more, more preferably 0.40 or more, and is preferably 0.95 or less, more preferably 0.90 or less.

The strain value (ε1) of the golf ball paint resin at which the stress becomes 0 kgf/cm² in the tensile test is preferably 40% or less, more preferably 38% or less, and even more preferably 36% or less. In addition, the strain value (ε1) is not particularly limited, and it is preferably 0% or more, more preferably 1% or more.

The stress M10 (also referred to as “10% elastic modulus”) of the golf ball paint resin at which the strain is 10% in the tensile test is preferably 5 kgf/cm² (0.49 MPa) or more, more preferably 10 kgf/cm² (0.98 MPa) or more, and even more preferably 15 kgf/cm² (1.47 MPa) or more, and is preferably 100 kgf/cm² (9.80 MPa) or less, more preferably 95 kgf/cm² (9.31 MPa) or less, and even more preferably 90 kgf/cm² (8.82 MPa) or less. If the stress M10 is 5 kgf/cm² or more and 100 kgf/cm² or less, the shot feeling of the golf ball hit with a putter is better.

The stress M50 (also referred to as “50% elastic modulus”) of the golf ball paint resin at which the strain is the predetermined value εmax (εmax=50%) in the tensile test is preferably 10 kgf/cm² or more, more preferably 20 kgf/cm² or more, and even more preferably 30 kgf/cm² or more, and is preferably 150 kgf/cm² or less, more preferably 140 kgf/cm² or less, and even more preferably 130 kgf/cm² or less. If the stress M50 falls within the above range, the shot feeling of the golf ball hit with a putter is better.

The tensile properties of the golf ball paint resin can be controlled by adjusting, for example, the type or amount of the constituent components of the golf ball paint resin.

The golf ball paint resin preferably comprises a polyurethane for the paint as a resin component. The amount of the polyurethane for the paint in the resin component is preferably 50 mass % or more, more preferably 70 mass % or more, and even more preferably 90 mass % or more. It is also preferable that the resin component of the paint substantially consists of the polyurethane for the paint.

The polyurethane for the paint is a polymer having a plurality of urethane bonds in the main chain. The polyurethane for the paint is preferably a polyurethane obtained by a reaction between a polyisocyanate composition containing a polyisocyanate and a polyol composition containing a polyol. A plurality of urethane bonds are formed in the main chain of the polyurethane through the reaction between the polyisocyanate and the polyol. The obtained polyurethane for the paint includes the polyisocyanate component derived from the polyisocyanate, and the polyol component derived from the polyol.

Examples of the polyol component constituting the polyurethane for the paint include a low molecular weight polyol having a molecular weight of less than 400, and a high molecular weight polyol having a number average molecular weight of 400 or more.

Examples of the high molecular weight polyol include a polyether polyol, a polyester polyol, a polycaprolactone polyol, a polycarbonate polyol, and an acrylic polyol. Examples of the polyether polyol include polyoxyethylene glycol (PEG), polyoxypropylene glycol (PPG), and polyoxytetramethylene glycol (PTMG). Examples of the polyether polyol include polyethylene adipate (PEA), polybutylene adipate (PBA), and polyhexamethylene adipate (PHMA). Examples of the polycaprolactone polyol include poly-ε-caprolactone (PCL). Examples of the polycarbonate polyol include polyhexamethylene carbonate. The high molecular weight polyol may be used solely, or two or more of them may be used in combination.

Examples of the low molecular weight polyol include a diol such as ethylene glycol, diethylene glycol, triethylene glycol, 1,3-butanediol, 1,4-butanediol, neopentyl glycol, and 1,6-hexanediol; and a triol such as glycerin, trimethylolpropane, and hexanetriol. The low molecular weight polyol may be used solely or as a mixture of at least two of them.

The polyurethane for the paint contained in the paint resin preferably includes at least one member selected from the group consisting of a polyether diol, a polyester diol, a polycaprolactone diol and a polycarbonate diol as a polyol component, more preferably includes the polycarbonate diol as the polyol component.

The polycarbonate diol is preferably a liquid polycarbonate diol. Herein, “liquid polycarbonate diol” means the polycarbonate diol is a viscous liquid at a temperature of 25° C. If the liquid polycarbonate diol is used, the paint film is softer and thus the shot feeling of the golf ball hit with a putter is better.

The number average molecular weight of the polycarbonate diol is preferably 400 or more, more preferably 450 or more, and even more preferably 500 or more, and is preferably 1200 or less, more preferably 1100 or less, and even more preferably 1000 or less. If the number average molecular weight of the polycarbonate diol is 400 or more and 1,200 or less, the distance between the crosslinking points in the paint film is appropriate, and thus the shot feeling of the golf ball hit with a putter is better. It is noted that the number average molecular weight of the polyol can be measured, for example, by gel permeation chromatography (GPC), using polystyrene as a standard material, tetrahydrofuran as an eluate, and an organic solvent system GPC column (e.g. “Shodex (registered trademark) KF series” available from Showa Denko K.K.) as a column.

Examples of the polyisocyanate component constituting the polyurethane comprised in the golf ball paint resin include a compound having at least two isocyanate groups. Examples of the polyisocyanate include an aromatic polyisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and para-phenylene diisocyanate (PPDI); an alicyclic polyisocyanate or aliphatic polyisocyanate such as 4,4′-dicyclohexylmethane diisocyanate (H₁₂MDI), hydrogenated xylylene diisocyanate (H₆XDI), hexamethylene diisocyanate (HDI), isophorone diisocyanate (IPDI), and norbornene diisocyanate (NBDI); and derivatives of these polyisocyanates. In the present disclosure, two or more of the polyisocyanates may be used in combination.

Examples of the derivatives of the polyisocyanate include an adduct-modified product obtained by a reaction between a diisocyanate and a polyhydric alcohol; an isocyanurate-modified product of a diisocyanate; a biuret-modified product; and an allophanate product, and the one from which free diisocyanate has been removed is more preferable. The polyisocyanate composition preferably contains, as a polyisocyanate component, at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate.

The biuret-modified product is, for example, a biuret-modified product in which a diisocyanate is trimerized (the following formula (1)). In the formula (1), R represents a residue where isocyanate groups are removed from the diisocyanate. The biuret-modified product is preferably a trimer of hexamethylene diisocyanate.

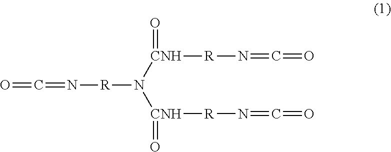

Examples of the isocyanurate-modified product include a trimer of diisocyanate represented by the following formula (2). In the formula (2), R represents a residue where isocyanate groups are removed from the diisocyanate. Examples of the isocyanurate-modified product include an isocyanurate-modified product of hexamethylene diisocyanate and an isocyanurate-modified product of isophorone diisocyanate, and a trimer of hexamethylene diisocyanate or a trimer of the isocyanurate-modified product of isophorone diisocyanate is preferable.

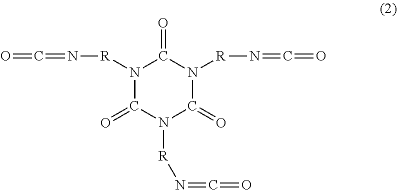

The adduct-modified product is a polyisocyanate obtained by a reaction between a diisocyanate and a polyhydric alcohol. The polyhydric alcohol is preferably a low molecular weight triol such as trimethylolpropane or glycerin. The adduct-modified product is preferably, for example, a triisocyanate (the following formula (3)) obtained by a reaction between a diisocyanate and trimethylolpropane, and a triisocyanate (the following formula (4)) obtained by a reaction between a diisocyanate and glycerin. In the formulae (3) and (4), R represents a residue where isocyanate groups are removed from the diisocyanate.

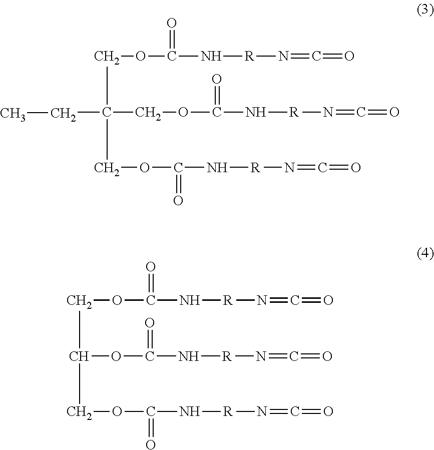

The adduct-modified product is preferably, for example, an adduct-modified product of hexamethylene diisocyanate, more preferably a triisocyanate obtained by a reaction between hexamethylene diisocyanate and trimethylolpropane, and a triisocyanate obtained by a reaction between hexamethylene diisocyanate and glycerin.

The allophanate product is, for example, a triisocyanate obtained by further reacting a diisocyanate with a urethane bond formed by a reaction between a diisocyanate and a low molecular weight diol.

### (Adduct-Modified Product)

In a preferable embodiment, the polyisocyanate component is preferably the adduct-modified product, more preferably the adduct-modified product of hexamethylene diisocyanate (preferably a trimer). In the case that the adduct-modified product of hexamethylene diisocyanate is used, the amount of the adduct-modified product of hexamethylene diisocyanate in the polyisocyanate component is preferably 10 mass % or more, more preferably 20 mass % or more, and even more preferably 30 mass % or more. The polyisocyanate component may consist of the adduct-modified product of hexamethylene diisocyanate.

### (Isocyanurate-Modified Product)

In another preferable embodiment, the polyisocyanate component is preferably the isocyanurate-modified product, more preferably the isocyanurate-modified product of hexamethylene diisocyanate (preferably a trimer) or the isocyanurate-modified product of isophorone diisocyanate (preferably a trimer). The isocyanurate-modified product of hexamethylene diisocyanate (preferably a trimer) and the isocyanurate-modified product of isophorone diisocyanate (preferably a trimer) may be used in combination. In the case that the isocyanurate-modified product of hexamethylene diisocyanate and the isocyanurate-modified product of isophorone diisocyanate are used in combination, the mass ratio (isocyanurate-modified product of hexamethylene diisocyanate/isocyanurate-modified product of isophorone diisocyanate) of the isocyanurate-modified product of hexamethylene diisocyanate to the isocyanurate-modified product of isophorone diisocyanate is preferably 0.1 or more, more preferably 0.2 or more, and even more preferably 0.3 or more, and is preferably 9 or less, more preferably 4 or less, and even more preferably 3 or less.

### (Adduct-Modified Product+Isocyanurate-Modified Product)

In another preferable embodiment, the polyisocyanate component is preferably a combination of the adduct-modified product and the isocyanurate-modified product, more preferably a combination of the adduct-modified product of hexamethylene diisocyanate (preferably a trimer) and the isocyanurate-modified product of hexamethylene diisocyanate (preferably a trimer), or a combination of the adduct-modified product of hexamethylene diisocyanate (preferably a trimer) and the isocyanurate-modified product of isophorone diisocyanate (preferably a trimer). In this case, the mass ratio (adduct-modified product/isocyanurate-modified product) of the adduct-modified product to the isocyanurate-modified product is preferably 0.1 or more, more preferably 0.3 or more, and even more preferably 0.4 or more, and is preferably 9 or less, more preferably 5 or less, and even more preferably 4 or less.

### (HDI Adduct-Modified Product+HDI Isocyanurate-Modified Product)

In another preferable embodiment, when the adduct-modified product of hexamethylene diisocyanate and the isocyanurate-modified product of hexamethylene diisocyanate are used as the polyisocyanate component, the total amount of the adduct-modified product of hexamethylene diisocyanate and the isocyanurate-modified product of hexamethylene diisocyanate in the polyisocyanate component is preferably 70 mass % or more, more preferably 80 mass % or more, and even more preferably 90 mass % or more. It is also preferable that the polyisocyanate component consists of the adduct-modified product of hexamethylene diisocyanate and the isocyanurate-modified product of hexamethylene diisocyanate.

### (HDI Isocyanurate-Modified Product+IPDI Isocyanurate-Modified Product)

In another preferable embodiment, when the isocyanurate-modified product of hexamethylene diisocyanate and the isocyanurate-modified product of isophorone diisocyanate are used as the polyisocyanate component, the total amount of the isocyanurate-modified product of hexamethylene diisocyanate and the isocyanurate-modified product of isophorone diisocyanate in the polyisocyanate component is preferably 70 mass % or more, more preferably 80 mass % or more, and even more preferably 90 mass % or more. It is also preferable that the polyisocyanate component consists of the isocyanurate-modified product of hexamethylene diisocyanate and the isocyanurate-modified product of isophorone diisocyanate.

### (HDI Adduct-Modified Product+IPDI Isocyanurate-Modified Product)

In another preferable embodiment, when the adduct-modified product of hexamethylene diisocyanate and the isocyanurate-modified product of isophorone diisocyanate are used as the polyisocyanate component, the total amount of the adduct-modified product of hexamethylene diisocyanate and the isocyanurate-modified product of isophorone diisocyanate in the polyisocyanate component is preferably 70 mass % or more, more preferably 80 mass % or more, and even more preferably 90 mass % or more. It is also preferable that the polyisocyanate component consists of the adduct-modified product of hexamethylene diisocyanate and the isocyanurate-modified product of isophorone diisocyanate.

The amount of the isocyanate group (NCO %) included in the polyisocyanate component is preferably 0.5 mass % or more, more preferably 1.0 mass % or more, and even more preferably 2.0 mass % or more, and is preferably 45 mass % or less, more preferably 40 mass % or less, and even more preferably 35 mass % or less. It is noted that the amount of the isocyanate group (NCO %) included in the polyisocyanate component can be represented by the following expression.

$$NCO ( \% ) = 100 \times [ mole number of the isocyanate group included in the polyisocyanate \times 42 ( molecular weight of NCO ) ] / [ total mass ( g ) of the polyisocyanate ]$$

Specific examples of the polyisocyanate component include Burnock (registered trademark) D-800, Burnock DN-950, and Burnock DN-955 available from DIC corporation; Desmodur (registered trademark) N75MPA/X, Desmodur N3300, Desmodur N3390, Desmodur L75 (C), and Sumidur (registered trademark) E21-1 available from Sumika Covestro Urethane Company, Ltd.; Coronate (registered trademark) HX, Coronate HK, Coronate HL, and Coronate EH available from Tosoh Corporation; Duranate (registered trademark) 24A-100, Duranate 21S-75E, Duranate TPA-100, Durante TKA-100, Durante 24A-90CX, and Durante E402-80B available from Asahi Kasei Chemicals Corporation; and VESTANAT (registered trademark) T1890 available from Degussa.

The golf ball paint resin is preferably formed from a paint comprising a polyol composition containing a polyol component and a polyisocyanate composition containing a polyisocyanate component. Examples of the paint include a so-called curing type paint having the polyol composition as a base material and the polyisocyanate composition as a curing agent. Next, the materials for forming the polyurethane for the paint will be explained.

### (Polyol Composition)

The polyol composition preferably contains a urethane polyol as the polyol component. The urethane polyol is a compound having a plurality of urethane bonds in the molecule and having at least two hydroxyl groups in one molecule. Examples of the urethane polyol include a urethane prepolymer obtained by a reaction between a first polyol component and a first polyisocyanate component under a condition that the amount of hydroxyl groups in the first polyol component is excessive to the amount of isocyanate groups in the first polyisocyanate component.

It is preferable that the polyol composition contains the urethane polyol as the polyol component, and the urethane polyol includes the polycarbonate diol as the first polyol component. As the polycarbonate diol, those listed as the polycarbonate diol component constituting the polyurethane for the paint can be preferably used.

It is also preferable that the urethane polyol includes, as the first polyol component, a component derived from a low molecular weight polyol having a molecular weight of less than 400 or a high molecular weight polyol having a number average molecular weight of 400 or more, in addition to the polycarbonate diol.

Examples of the low molecular weight polyol include a diol such as ethylene glycol, diethylene glycol, triethylene glycol, 1,3-butanediol, 1,4-butanediol, neopentyl glycol, and 1,6-hexanediol; and a triol such as glycerin, trimethylolpropane, and hexanetriol. The low molecular weight polyol may be used solely or as a mixture of at least two of them.

Examples of the high molecular weight polyol include a polyether polyol, a polyester polyol, a polycaprolactone polyol, and an acrylic polyol. Examples of the polyether polyol include polyoxyethylene glycol (PEG), polyoxypropylene glycol (PPG), and polyoxytetramethylene glycol (PTMG). Examples of the polyester polyol include polyethylene adipate (PEA), polybutylene adipate (PBA), and polyhexamethylene adipate (PHMA). Examples of the polycaprolactone polyol include poly-ε-caprolactone (PCL). The high molecular weight polyol may be used solely or as a mixture of at least two of them.

The amount of the polycarbonate diol in the urethane polyol is preferably 20 mass % or more, more preferably 30 mass % or more, and even more preferably 40 mass % or more. In addition, the amount of the polycarbonate diol in the urethane polyol is preferably 90 mass % or less, more preferably 85 mass % or less, and even more preferably 80 mass % or less. It is noted that the amount of the polycarbonate diol in the urethane polyol can be calculated based on the blending ratio of the first polyol component to the first polyisocyanate component for forming the urethane polyol.

The urethane polyol preferably includes the triol component and the diol component as the first polyol component. As the triol component, trimethylolpropane is preferable. The mixing ratio of the triol component to the diol component (triol component/diol component) is preferably 1.0 or more, more preferably 1.2 or more, and is preferably 2.6 or less, more preferably 2.4 or less in a molar ratio.

The first polyisocyanate component constituting the urethane polyol is not particularly limited, as long as the first polyisocyanate component has at least two isocyanate groups. Examples of the first polyisocyanate component include an aromatic polyisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylenediisocyanate (TMXDI), and para-phenylene diisocyanate (PPDI); and an alicyclic polyisocyanate or aliphatic polyisocyanate such as 4,4′-dicyclohexylmethane diisocyanate (H₁₂MDI), hydrogenated xylylenediisocyanate (H₆XDI), hexamethylene diisocyanate (HDI), isophorone diisocyanate (IPDI), and norbornene diisocyanate (NBDI). These polyisocyanates may be used solely or as a mixture of at least two of them.

The urethane polyol preferably includes the alicyclic diisocyanate as the first polyisocyanate component.

The weight average molecular weight of the urethane polyol is preferably 5,000 or more, more preferably 5,300 or more, and even more preferably 5,500 or more, and is preferably 20,000 or less, more preferably 18,000 or less, and even more preferably 16,000 or less. If the weight average molecular weight of the urethane polyol is 5,000 or more and 20,000 or less, the shot feeling of the golf ball hit with a putter is better.

The hydroxyl value of the urethane polyol is preferably 10 mgKOH/g or more, more preferably 15 mgKOH/g or more, and even more preferably 20 mgKOH/g or more, and is preferably 200 mgKOH/g or less, more preferably 190 mgKOH/g or less, and even more preferably 180 mgKOH/g or less. It is noted that the hydroxyl value can be measured according to JIS K 1557-1, for example, by an acetylation method.

In a preferable embodiment, the polyol component of the polyol composition consists of the urethane polyol.

The amount of the urethane polyol in the polyol component contained in the polyol composition is preferably 50 mass % or more, more preferably 80 mass % or more, and even more preferably 90 mass % or more. The polyol component contained in the polyol composition also preferably consists of the urethane polyol.

### (Polyisocyanate Composition)

Examples of the polyisocyanate component of the polyisocyanate composition used in the present disclosure include those listed as the polyisocyanate constituting the polyurethane. Examples of the polyisocyanate include an aromatic polyisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylenediisocyanate (TMXDI), and para-phenylene diisocyanate (PPDI); an alicyclic polyisocyanate or aliphatic polyisocyanate such as 4,4′-dicyclohexylmethane diisocyanate (H₁₂MDI), hydrogenated xylylenediisocyanate (H₆XDI), hexamethylene diisocyanate (HDI), isophorone diisocyanate (IPDI), and norbornene diisocyanate (NBDI); and derivatives of these polyisocyanates. The polyisocyanate composition preferably contains the hexamethylene diisocyanate as the polyisocyanate component. In the present disclosure, at least two polyisocyanates may be used as the polyisocyanate.

Examples of the derivatives of the polyisocyanate include an adduct-modified product obtained by a reaction between a diisocyanate and a polyhydric alcohol; an isocyanurate-modified product of a diisocyanate; a biuret-modified product; and an allophanate-modified product. The derivative of the polyisocyanate from which free diisocyanate is removed is more preferable. The polyisocyanate composition preferably contains, as the polyisocyanate component, at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate. In addition, the polyisocyanate composition more preferably contains the isocyanurate-modified product of hexamethylene diisocyanate and the adduct-modified product of hexamethylene diisocyanate as the polyisocyanate component.

In the curing reaction of the curing type paint composition, the molar ratio (NCO group/OH group) of the isocyanate group (NCO group) included in the polyisocyanate composition to the hydroxyl group (OH group) included in the polyol composition is preferably 0.6 or more, more preferably 0.75 or more, and even more preferably 0.9 or more. If the molar ratio (NCO group/OH group) is 0.6 or more, the curing reaction is sufficient. The molar ratio (NCO group/OH group) is preferably 1.4 or less, more preferably 1.3 or less, and even more preferably 1.2 or less. If the molar ratio (NCO group/OH group) is 1.4 or less, the amount of the isocyanate group is not excessive, and the obtained paint film has more appropriate hardness and better appearance.

The paint may be either a waterborne paint mainly containing water as a dispersion medium or a solvent-based paint containing an organic solvent as a dispersion medium, and the solvent-based paint is preferable. In case of the solvent-based paint, preferable examples of the solvent include toluene, isopropyl alcohol, xylene, methyl ethyl ketone, methyl ethyl isobutyl ketone, ethylene glycol monomethyl ether, ethylbenzene, propylene glycol monomethyl ether, isobutyl alcohol, and ethyl acetate. It is noted that the solvent may be blended in either the polyol composition or the polyisocyanate composition. From the viewpoint of uniformly performing the curing reaction, the solvent is preferably blended in each of the polyol composition and the polyisocyanate composition.

A conventionally known catalyst can be employed in the curing reaction. Examples of the catalyst include a monoamine such as triethyl amine and N,N-dimethylcyclohexylamine; a polyamine such as N,N,N′,N′-tetramethylethylene diamine and N,N,N′,N″,N″-pentamethyldiethylene triamine; a cyclic diamine such as 1,8-diazabicyclo[5.4.0]-7-undecene (DBU) and triethylene diamine; a tin catalyst such as dibutyl tin dilaurate and dibutyl tin diacetate. These catalysts may be used solely, or two or more of the catalysts may be used in combination. Among them, the tin catalyst such as dibutyl tin dilaurate and dibutyl tin diacetate is preferable, dibutyl tin dilaurate is particularly preferable.

The paint may further include additives that can be generally included in a paint for a golf ball, such as an ultraviolet absorber, an antioxidant, a light stabilizer, a fluorescent brightener, an anti-blocking agent, a leveling agent, a slip agent, and a viscosity modifier, where necessary.

The golf ball according to the present disclosure is a golf ball comprising a golf ball body and a paint film composed of at least one layer and formed on a surface of the golf ball body, wherein at least an outermost layer of the paint film is formed from the golf ball paint resin according to the present disclosure.

When the paint film has a multiple layered structure, the layer positioned on the outermost side of the paint film is the outermost layer of the paint film. When the paint film has a single layered structure, the single layered paint film is the outermost layer of the paint film.

When the paint film has a multiple layered structure, examples of the base resin constituting the paint film layer other than the outermost paint film layer include a polyurethane, an epoxy resin, an acrylic resin, a vinyl acetate resin, and a polyester resin, and among them, the polyurethane is preferable. In addition, as the base resin constituting the paint film layer other than the outermost paint film layer, the polyurethane used for the above-described outermost paint film layer may be used.

The thickness of the paint film formed from the golf ball paint resin is preferably 5 μm or more, more preferably 7 μm or more, and even more preferably 9 μm or more, and is preferably 40 μm or less, more preferably 30 μm or less, and even more preferably 20 μm or less. If the thickness of the paint film falls within the above range, the appearance is better.

When the golf ball has a multiple layered paint film, the total thickness of the whole paint film is preferably 5 μm or more, more preferably 7 μm or more, and even more preferably 9 μm or more, and is preferably 50 μm or less, more preferably 45 μm or less, and even more preferably 40 μm or less. If the thickness film falls within the above range, the appearance is better.

### (Formation of Paint Film)

The paint film can be formed by applying the paint on the surface of the golf ball body. The method of applying the paint is not particularly limited, a conventional method can be adopted, and examples thereof include a spray coating and electrostatic coating.

In the case of performing the spray coating with an air gun, the polyisocyanate composition and the polyol composition are fed with respective pumps and continuously mixed with a line mixer located in the stream line just before the air gun, and the obtained mixture is air-sprayed. Alternatively, the polyisocyanate composition and the polyol composition are air-sprayed respectively with an air spray system provided with a device for controlling the mixing ratio thereof. The paint application may be conducted by spraying the paint one time or overspraying the paint multiple times.

The paint applied on the golf ball body can be dried, for example, at a temperature in a range of from 30° C. to 70° C. for 1 hour to 24 hours, to form the paint film.

### (Golf Ball)

The golf ball according to the present disclosure is not particularly limited, as long as the golf ball comprises a golf ball body composed of a spherical core and a cover, and a paint film formed on a surface of the golf ball body and composed of at least one layer. The construction of the golf ball body is not particularly limited, and the golf ball may be a two-piece golf ball composed of a single layered spherical core and a cover, a three-piece golf ball composed of a single layered spherical core, an intermediate layer and a cover, a four-piece golf ball, or a multi-piece golf ball composed of five or more pieces. The present disclosure can be suitably applied to any one of the above golf balls.

The golf ball according to the present disclosure preferably has a diameter in a range from 40 mm to 45 mm. In light of satisfying the regulation of US Golf Association (USGA), the diameter is particularly preferably 42.67 mm or more. In light of prevention of air resistance, the diameter is more preferably 44 mm or less, even more preferably 42.80 mm or less. In addition, the golf ball according to the present disclosure preferably has a mass of 40 g or more and 50 g or less. In light of obtaining greater inertia, the mass is more preferably 44.00 g or more, even more preferably 45.00 g or more. In light of satisfying the regulation of USGA, the mass is particularly preferably 45.93 g or less.

When the golf ball according to the present disclosure has a diameter in a range from 40 mm to 45 mm, the compression deformation amount (shrinking amount along the compression direction) of the golf ball when applying a load from 98 N as an initial load to 1275 N as a final load to the golf ball is preferably 2.70 mm or more, more preferably 2.75 mm or more, and even more preferably 2.80 mm or more, and is preferably 3.15 mm or less, more preferably 3.10 mm or less, and even more preferably 3.05 mm or less. If the compression deformation amount is 2.70 mm or more, the golf ball is not excessively hard and thus the shot feeling thereof is better. On the other hand, if the compression deformation amount is less than 3.15 mm, the initial velocity on drive shots is fast, and the flight distance performance improves.

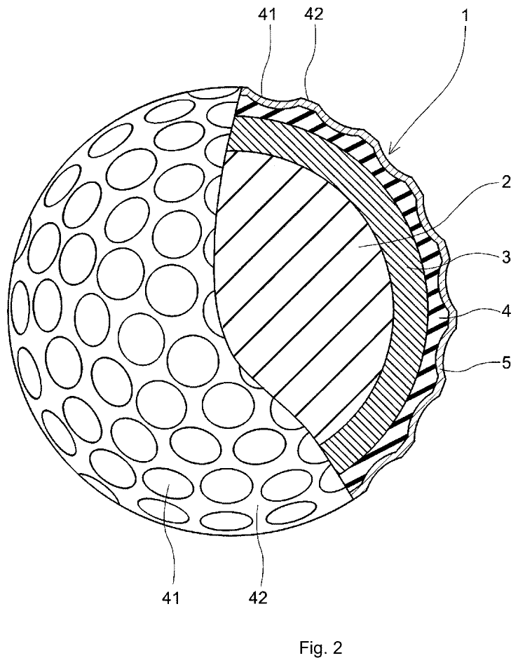

FIG. 2 is a partially cutaway cross-sectional view of a golf ball 1 according to one embodiment of the present disclosure. The golf ball 1 comprises a spherical core 2, an intermediate layer 3 covering the spherical core, a cover 4 covering the intermediate layer, and a paint film 5 formed on a surface of the cover. A plurality of dimples 41 are formed on the surface of the cover. Other portions than the dimples 41 on the surface of the cover are lands 42.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Method]

### (1) Compression Deformation Amount (mm)

The compression deformation amount was measured with a YAMADA type compression tester “SCH”. The golf ball or spherical core was placed on a metal rigid plate of the tester. A metal cylinder slowly fell toward the golf ball or spherical core. The golf ball or spherical core sandwiched between the bottom of the cylinder and the rigid plate deformed. The travelling distance of the cylinder was measured when applying a load from an initial load of 98 N to a final load of 1275 N to the golf ball or spherical core. The compression deformation amount (mm) was the travelling distance. The travelling speed of the cylinder before applying the initial load was 0.83 mm/s. The travelling speed of the cylinder when applying the load from the initial load to the final load was 1.67 mm/s.

### (2) Core Hardness (Shore C Hardness)

The hardness measured at the surface portion of the core was adopted as the surface hardness of the core. In addition, the core was cut into two hemispheres to obtain a cut plane, and the hardness at the central point of the cut plane and the hardness at the predetermined distance from the central point in the radius direction were measured. It is noted that each hardness was measured at four points, and the average value thereof was calculated. An automatic hardness tester (Digitest II, available from Bareiss company) using a testing device of “Shore C” was used to measure the hardness.

### (3) Slab Hardness of Intermediate Layer Composition (Shore D Hardness)

Sheets with a thickness of about 2 mm were produced by injection molding the intermediate layer composition. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II available from Bareiss company) using a detector of “Shore D”.

### (4) Number Average Molecular Weight of Polyol

Gel permeation chromatography was conducted to determine the number average molecular weight of the polyol under the following measuring conditions.

### <Measuring Conditions>

Apparatus: HLC-8120GPC available from Tosoh Corporation
Eluent: tetrahydrofuran (THF)
Temperature: 40° C.
Column: TSK gel Super HM-M (available from Tosoh Corporation)
Polyol concentration: 0.2 mass % (polyol/(polyol+THF))
Sample injection volume: 5 μL
Flow rate: 0.5 mL/min
Molecular weight standard: polystyrene (PSt Quick Kit-H available from Tosoh Corporation)

### (5) Slab Hardness of Cover Material (Shore A Hardness)

Sheets with a thickness of about 2 mm were prepared by injection molding the cover material. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II available from Bareiss company) using a detector of “Shore A”.

### (6) Loss Modulus E″ (Pa)

The loss modulus E″ (Pa) of the cover material was measured under the following conditions.

Apparatus: dynamic viscoelasticity measuring apparatus “Rheogel-E4000” available from UBM corporation

Measured sample: a sheet with a thickness of 0.5 mm was produced by heat pressing the cover material, and a test piece was cut from the sheet to have a width of 4 mm and a length between clamps of 20 mm.

### <Measuring Conditions>

measuring mode: tensile mode
measuring temperature: −100° C. to 100° C.
temperature rising rate: 4° C./min
oscillation frequency: 10 Hz
measuring strain: 0.05%

### (7) Tensile Test

A paint obtained by blending the polyisocyanate composition and the polyol composition was dried and cured at a temperature of 40° C. for 4 hours to prepare a paint film (thickness: 100 μm plus or minus 10 μm).

The paint film was cut into a shape with a width of 4 mm and a length of 30 mm to prepare a test piece. The tensile test was conducted with a dynamic viscoelasticity measuring apparatus (Rheogel-E4000 available from UBM CO., Ltd.) under the following test conditions.

### <Test Conditions>

distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%)

### (8) Thickness of Paint Film (μm)

The golf ball was cut into two hemispheres, and the cross section of the paint film on the hemisphere was observed with a microscope (VHX-1000 available from Keyence Corporation) to obtain the thickness of the paint film.

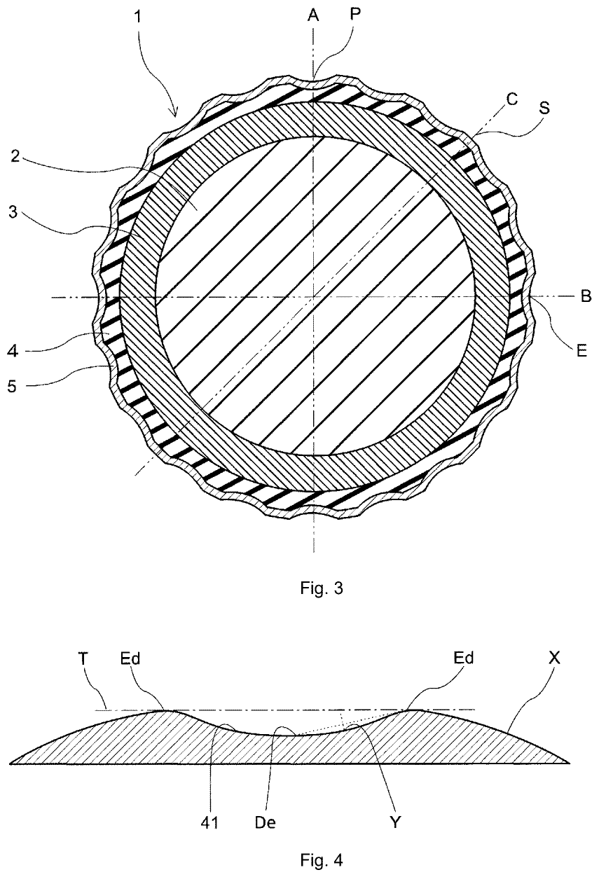

The measuring location of the film thickness will be explained by reference to FIGS. 3 and 4. FIG. 3 is a schematic figure of a cross section of a golf ball. As shown in FIG. 3, on the cross section of the golf ball, a straight line A is drawn to pass a central point of the ball and a bottom of any dimple, a straight line B perpendicular to the straight line A is drawn to pass the central point of the golf ball, and a straight line C is drawn to have an angle of 45° to the straight line A on the A-B plane, and intersection points of these straight lines with the paint film surface are adopted as a pole P, an equator E and a shoulder S, respectively.

FIG. 4 is a schematic figure of a cross section passing a bottom De of a dimple 41 and a central point of a golf ball 1. The bottom De of the dimple 41 is the deepest location of the dimple 41. An edge Ed is a point of tangency of the dimple 41 with a tangent T, wherein the tangent T is drawn by connecting both sides of the dimple 41. A measuring location Y on an inclined plane is a point at which a perpendicular line intersects with the inclined plane of the dimple, wherein the perpendicular line is drawn from a midpoint of a straight line connecting the bottom De of the dimple and the edge Ed downward to the dimple 41. A measuring location X on a land is a midpoint between edges of adjacent dimples. It is noted that in the case that adjacent dimples contact each other so that no land exists, or in the case that the land is so narrow that the thickness is hard to be measured, the bottom, edge or inclined plane of the dimple is adopted as the measuring point.

In the measurement, test samples were prepared from three locations of six balls, i.e. the dimple where the pole P exists, the dimple near the equator E and the dimple near the shoulder S, were firstly prepared. Next, regarding each test piece (dimple), the thickness of the paint film at the bottom De, edge Ed, inclined plane Y and land X of the dimple was measured. Finally, measuring values of six balls were averaged, and the obtained average value was adopted as the thickness of the paint film.

### (9) Wear Resistance of Ball Surface

In a ball mill having a volume of 7 liters, 2500 g of grinding stone (“AT3” available from Tipton Corporation) and 2500 ml of water were filled. In this ball mill, 40 golf balls were charged. The ball mill was rotated at a rotation speed of 50 rpm for 1 hour, and the appearance of the golf balls after the ball milling was visually checked and evaluated as follows.
E (excellent): Number of the balls where the paint film has a peeling spot whose area is same to or larger than one dimple, is less than 5.
G (good): Number of the balls where the paint film has a peeling spot whose area is same to or larger than one dimple, is 5 or more and less than 10.
F (fair): Number of the balls where the paint film has a peeling spot whose area is same to or larger than one dimple, is 10 or more and less than 20.
P (poor): Number of the balls where the paint film has a peeling spot whose area is same to or larger than one dimple, is 20 or more.

### (10) Stain Resistance on Bunker Shots

A sand wedge (trade name: “RTX6 ZIPCORE”, loft angel: 58°, available from Cleveland Golf Inc.) was installed on a swing machine available from Golf Laboratories, Inc. The golf balls set in the bunker were hit at a head speed of 16 m/s. Each golf ball was hit ten times. The golf ball after the hitting was visually observed by 20 golfer players. The number of the players who answered that he or she was conscious of stain was counted, and the stain resistance was evaluated according to the following standard.
E (excellent): 5 persons or less
G (Good): 6 persons or more and 10 persons or less
F (Fair): 11 persons or more and 15 persons or less
P (Poor): 16 persons or more
   (11) Spin Rate on Approach Shots from the Rough (Under a Condition that there is Grass Between the Golf Ball and the Club Face)

A sand wedge (trade name: “RTX6 ZIPCORE”, loft angel: 58°, available from Cleveland Golf Inc.) was installed on a swing machine available from Golf Laboratories, Inc. The golf balls were hit at a head speed of 16 m/s, and the spin rate (rpm) thereof was measured by continuously taking a sequence of photographs of the hit golf balls. It is noted that two leaves (length: about 3 cm) of wild grass were attached to the golf ball that was the testing object, and the golf balls were hit such that there was the wild grass between the club face and the golf ball. The measurement was conducted ten times for each golf ball, and the average value thereof was adopted as the spin rate. It is noted that the spin rate of each golf ball in Tables 7 to 9 is shown as a difference from the spin rate of the golf ball No. 1, and evaluated according to the following standard.
E (excellent): 0 rpm or more
G (Good): −90 rpm or more and less than 0 rpm
F (Fair): −180 rpm or more and less than −90 rpm
P (Poor): less than −180 rpm

### (12) Spin Rate on 8-Iron Shots

An 8-iron (SRIXON (registered trademark) ZX7 MkII, loft angle: 36°, shaft hardness: S, available from Sumitomo Rubber Industries, Ltd.) was installed on a swing robot M/C available from True Temper Sports, Inc. The golf balls were hit at a head speed of 39 m/sec, and the spin rate of the golf ball right after being hit was measured. The measurement was conducted ten times for each golf ball, and the average value thereof was adopted as the measurement value for that golf ball. It is noted that the spin rate of the golf ball right after being hit was measured by continuously taking a sequence of photographs of the hit golf balls. It is noted that the spin rate of each golf ball in Tables 7 to 9 is shown as a difference from the spin rate of the golf ball No. 1, and evaluated according to the following standard.
E (excellent): 0 rpm or more
G (Good): −130 rpm or more and less than 0 rpm
F (Fair): −260 rpm or more and less than −130 rpm
P (Poor): less than −260 rpm [0176]

### (13) Initial Velocity, Spin Rate and Flight Distance on Driver Shots

A driver (SRIXON (registered trademark) ZX7 MkII, loft angle: 10.5°, shaft hardness: S, available from Sumitomo Rubber Industries, Ltd.) was installed on a swing robot M/C available from True Temper Sports, Inc. The golf balls were hit at a head speed of 50 m/sec, and the ball speed (initial velocity) and spin rate of the golf balls right after being hit, and the flight distance (the distance from the launch point to the stop point) were measured. The measurement was conducted ten times for each golf ball, and the average value thereof was adopted as the measurement value for that golf ball. It is noted that the spin rate of the golf balls right after being hit was measured by continuously taking a sequence of photographs of the hit golf balls. It is noted that the spin rate, initial velocity or flight distance of each golf ball in Tables 7 to 9 is shown as a difference from the spin rate, initial velocity or flight distance of the golf ball No. 1, and evaluated according to the following standard.
E (excellent): 0 yd or more
G (Good): −0.7 yd or more and less than 0 yd
F (Fair): −1.4 yd or more and less than −0.7 yd
P (Poor): less than −1.4 yd

### (14) Shot Feeling on Driver Shots

The golf balls were hit with a driver (SRIXON (registered trademark) ZX7 MkII, loft angle: 10.5°, shaft hardness: S, available from Sumitomo Rubber Industries, Ltd.) by 20 golfers, and the shot feeling thereof was evaluated in three grades of hard, ordinary and soft.

### Evaluation Standard

E (excellent): There were 16 or more golfers who evaluated that the shot feeling was soft.
G (Good): There were 12 or more and 15 or less golfers who evaluated that the shot feeling was soft.
F (Fair): There were 8 or more and 11 or less golfers who evaluated that the shot feeling was soft.
P (Poor): There were 7 or less golfers who evaluated that the shot feeling was soft.

### (15) Shot Feeling on 8-Iron Shots

The golf balls were hit with an 8-iron (SRIXON (registered trademark) ZX7 MkII, loft angle: 36°, shaft hardness: S, available from Sumitomo Rubber Industries, Ltd.) by 20 golfers, and the shot feeling thereof was evaluated in three grades of hard, ordinary and soft.

### Evaluation Standard

E (excellent): There were 16 or more golfers who evaluated that the shot feeling was soft.
G (Good): There were 12 or more and 15 or less golfers who evaluated that the shot feeling was soft.
F (Fair): There were 8 or more and 11 or less golfers who evaluated that the shot feeling was soft.
P (Poor): There were 7 or less golfers who evaluated that the shot feeling was soft.

### (14) Comprehensive Evaluation

Based on the results of the wear resistance of a ball surface, the stain resistance on shots from the bunker, the spin rate on approach shots from the rough (under a condition that there is grass between the golf ball and the club face), the spin rate on 8-iron shots, and the flight distance on driver shots, the shot feeling on driver shots and the shot feeling on 8-iron shots, the comprehensive evaluation was conducted for each golf ball according to the following standard.
G (Good): There is no F (Fair) or P (Poor) in each of the evaluations.
F (Fair): There is one or more F (Fair) but there is no P (Poor) in each of the evaluations.
P (Poor): There is one or more P (Poor) in each of the evaluations.

### [Production of Golf Ball]

### (1) Production of Spherical Core

The materials having the formulations shown in Table 1 were kneaded with a kneading roll to obtain the core compositions.

The core compositions shown in Table 1 were heat pressed in upper and lower molds, each having a hemispherical cavity, to obtain the spherical cores. It is noted that barium sulfate was added in an appropriate amount such that the obtained golf balls had a mass of 45.6 g.

TABLE 1

| Spherical core No. | | | 1 | 2 | 3 | 4 | 5 | 6 | 7 | 8 |
|---|---|---|---|---|---|---|---|---|---|---|
| Formulation | Polybutadiene | | 100 | 100 | 100 | 100 | 100 | 100 | 100 | 100 |
| of rubber | Zinc diacrylate | | 29 | 26 | 27 | 26 | 26 | 24 | 34.5 | 32 |
| composition | Zinc oxide | | 10 | 10 | 10 | 10 | 10 | 10 | 5 | 10 |
| (parts by | Barium sulfate | | * | * | * | * | * | * | * | * |
| mass) | Benzoic acid | | — | 1.5 | — | 1.0 | — | 3.0 | — | 2.0 |
| | 4-Methoxyphenol | | — | 0.1 | — | 0.1 | 0.1 | 0.1 | — | — |
| | H-BHT | | — | — | — | — | — | — | — | — |
| | PBDS | | 0.4 | 0.4 | 0.4 | 0.4 | 0.4 | 0.4 | — | 0.4 |
| | DPDS | | — | — | — | — | — | — | 0.5 | — |
| | DCP | | 0.7 | 1.2 | 0.7 | 1.2 | 1.0 | 1.2 | 0.7 | 0.7 |
| Molding | First stage | Temperature | 142 | 156 | 142 | 156 | 156 | 160 | 170 | 150 |
| conditions | vulcanization | [° C.] | | | | | | | | |
| | | Time [min] | 10 | 18 | 10 | 18 | 18 | 16 | 14 | 19 |
| | Second stage | Temperature | 155 | — | 155 | — | — | — | — | — |
| | vulcanization | [° C.] | | | | | | | | |
| | | Time [min] | 12 | — | 12 | — | — | — | — | — |
| Diameter (mm) | | | 39.5 | 39.5 | 39.5 | 39.5 | 39.5 | 39.5 | 39.5 | 39.5 |
| Compression deformation amount (mm) | | | 3.35 | 3.35 | 3.55 | 3.35 | 3.35 | 3.36 | 3.25 | 3.22 |
| Hardness | Center hardness (H₀) | | 61 | 59 | 59 | 60 | 62 | 54 | 62 | 54 |
| distribution | Hardness (H₅) at 5.0 mm | | 69 | 67 | 67 | 68 | 68 | 62 | 70 | 63 |
| (Shore C) | point from center | | | | | | | | | |
| | Hardness (H₁₀) at 10 mm | | 71 | 70 | 69 | 70 | 70 | 65 | 70 | 69 |
| | point from center | | | | | | | | | |
| | Hardness (H₁₅) at 15 mm | | 78 | 78 | 76 | 78 | 77 | 76 | 74 | 78 |
| | point from center | | | | | | | | | |
| | Surface hardness (Hs) | | 79 | 79 | 78 | 79 | 78 | 77 | 80 | 79 |
| (H₅ − H₀) − (H₁₅ − H₁₀) | | | 1.0 | 0.0 | 1.0 | 0.0 | −1.0 | −3.0 | 4.0 | 0.0 |
| (H₁₀ − H₅) − (Hs − H₁₅) | | | 1.0 | 2.0 | 0.0 | 1.0 | 1.0 | 2.0 | −6.0 | 5.0 |
| [{(H₅ − H₀) + (H₁₅ − H₁₀)}/2] − | | | 6.0 | 6.0 | 5.5 | 6.5 | 5.0 | 7.5 | 3.0 | 5.5 |
| [{(H₁₀ − H₅) + (Hs − H₁₅)}/2] | | | | | | | | | | |
| {(H₅ − H₀) + (H₁₅ − H₁₀)}/2 | | | 7.5 | 8.0 | 7.5 | 8.0 | 6.5 | 9.5 | 6.0 | 9.0 |
| {(H₁₀ − H₅) + (Hs − H₁₅)}/2 | | | 1.5 | 2.0 | 2.0 | 1.5 | 1.5 | 2.0 | 3.0 | 3.5 |
| (H₅ + H₁₀ + H₁₅)/3 | | | 72.7 | 71.7 | 70.7 | 72.0 | 71.7 | 67.7 | 71.3 | 70.0 |
| Hs − H₀ | | | 18.0 | 20.0 | 19.0 | 19.0 | 16.0 | 23.0 | 18.0 | 25.0 |
| Spherical core No. | | | 9 | 10 | 11 | 12 | 13 | 14 | 15 | 16 |
| Formulation | Polybutadiene | | 100 | 100 | 100 | 100 | 100 | 100 | 100 | 100 |
| of rubber | Zinc diacrylate | | 32 | 28 | 30 | 29 | 29 | 29 | 29 | 26 |
| composition | Zinc oxide | | 3 | 5 | 5 | 10 | 10 | 10 | 10 | 10 |
| (parts by | Barium sulfate | | * | * | * | * | * | * | * | * |
| mass) | Benzoic acid | | — | — | 1.5 | — | — | — | — | 1.0 |
| | 4-Methoxyphenol | | — | — | 0.1 | — | — | — | — | 0.1 |
| | H-BHT | | — | 2 | — | — | — | — | — | — |
| | PBDS | | — | 0.2 | 0.4 | 0.4 | 0.4 | 0.4 | 0.4 | 0.4 |
| | DPDS | | 0.5 | — | — | — | — | — | — | — |
| | DCP | | 0.7 | 0.9 | 1.2 | 0.7 | 0.7 | 0.7 | 0.7 | 1.2 |
| Molding | First stage | Temperature | 170 | 170 | 156 | 142 | 142 | 140 | 142 | 156 |
| conditions | vulcanization | [° C.] | | | | | | | | |
| | | Time [min] | 15 | 20 | 18 | 10 | 10 | 10 | 10 | 18 |
| | Second stage | Temperature | — | — | — | 155 | 155 | 160 | 170 | — |
| | vulcanization | [° C.] | | | | | | | | |
| | | Time [min] | — | — | — | 12 | 12 | 12 | 12 | — |

| Diameter (mm) | | 39.5 | 39.5 | 39.5 | 39.9 | 38.9 | 39.5 | 39.5 | 38.3 |
|---|---|---|---|---|---|---|---|---|---|
| Compression deformation amount (mm) | | 3.35 | 3.35 | 2.95 | 3.35 | 3.35 | 3.28 | 3.50 | 3.38 |
| Hardness | Center hardness (H₀) | 60 | 60 | 61 | 61 | 61 | 59 | 58 | 59 |
| distribution | Hardness (H₅) at 5.0 mm | 67 | 69 | 69 | 69 | 69 | 68 | 69 | 67 |
| (Shore C) | point from center | | | | | | | | |
| | Hardness (H₁₀) at 10 mm | 68 | 72 | 72 | 71 | 71 | 71 | 71 | 69 |
| | point from center | | | | | | | | |
| | Hardness (H₁₅) at 15 mm | 74 | 77 | 80 | 78 | 78 | 78 | 78 | 77 |
| | point from center | | | | | | | | |
| | Surface hardness (Hs) | 78 | 81 | 81 | 79 | 79 | 81 | 81 | 78 |

| | | | | | | | | |
|---|---|---|---|---|---|---|---|---|
| (H₅ − H₀) − (H₁₅ − H₁₀) | 1.0 | 4.0 | 0.0 | 1.0 | 1.0 | 2.0 | 4.0 | 0.0 |
| (H₁₀ − H₅) − (Hs − H₁₅) | −3.0 | −1.0 | 2.0 | 1.0 | 1.0 | 0.0 | −1.0 | 1.0 |
| [{(H₅ − H₀) + (H₁₅ − H₁₀)}/2] − | 4.0 | 3.5 | 6.0 | 6.0 | 6.0 | 5.0 | 6.5 | 6.5 |
| [{(H₁₀ − H₅) + (Hs − H₁₅)}/2] | | | | | | | | |
| {(H₅ − H₀) + (H₁₅ − H₁₀)}/2 | 6.5 | 7.0 | 8.0 | 7.5 | 7.5 | 8.0 | 9.0 | 8.0 |
| {(H₁₀ − H₅) + (Hs − H₁₅)}/2 | 2.5 | 3.5 | 2.0 | 1.5 | 1.5 | 3.0 | 2.5 | 1.5 |
| (H₅ + H₁₀ + H₁₅)/3 | 69.7 | 72.7 | 73.7 | 72.7 | 72.7 | 72.3 | 72.7 | 71.0 |
| Hs − H₀ | 18.0 | 21.0 | 20.0 | 18.0 | 18.0 | 22.0 | 23.0 | 19.0 |

*Appropriate amount

The materials used in Table 1 are shown as below.
Polybutadiene rubber: “BR-730” (high-cis polybutadiene rubber, amount of cis-1,4 bond: 95 mass %, amount of 1,2-vinyl bond: 1.3 mass %, Moony viscosity (ML₁₊₄ (100° C.): 55, molecular weight distribution (Mw/Mn): 3) available from JSR Corporation
Zinc diacrylate: “ZN-DA90S” available from Nisshoku Techno Fine Chemical Co., Ltd.
Zinc oxide: “Ginrei R” available from Toho Zinc Co., Ltd.
Barium sulfate: “Barium sulfate BD” available from Sakai Chemical Industry Co., Ltd.
Benzoic acid: available from Emerald Kalama Chemical LLC 4-Methoxyphenol: available from Tokyo Chemical Industry Co., Ltd.
H-BHT: dibutylhydroxytoluene available from Tokyo Zairyo Co., Ltd.
PBDS: bis(pentabromophenyl) disulfide available from Kawaguchi Chemical Industry Co., Ltd.
DPDS: diphenyl disulfide available from Sumitomo Seika Chemicals Co., Ltd.
DCP: “Percumyl (registered trademark) D” (dicumyl peroxide) available from NOF Corporation

### (2) Formation of Intermediate Layer

According to the formulations shown in Table 2, the materials were extruded with a twin-screw kneading type extruder to prepare the intermediate layer compositions in a pellet form.

The obtained intermediate layer compositions were injection molded on the spherical cores obtained above to cover the spherical cores such that an intermediate layer with a predetermined thickness was formed, thereby producing intermediate layer-covering spherical bodies.

TABLE 2

| | | |
|---|---|---|
| Intermediate layer composition No. | A | B |

| | | | |
|---|---|---|---|
| Formulation | Himilan AM7337 | 50 | — |
| (parts by mass) | Himilan AM7938 | 50 | — |
| | U161-RV2 | — | 100 |
| | Titanium dioxide | 4 | 4 |

| | | |
|---|---|---|
| Slab hardness (Shore D) | 69 | 72 |

Himilan (registered trademark) AM7337: sodium ion neutralized ethylene-methacrylic acid copolymer ionomer resin available from Dow-Mitsui Polychemicals Co., Ltd.
Himilan (registered trademark) AM7938: zinc ion neutralized ethylene-methacrylic acid copolymer ionomer resin available from Dow-Mitsui Polychemicals Co., Ltd.
U161-RV2: polyamide resin available from Toray Industries, Inc
Titanium dioxide: A-220 available from Ishihara Sangyo Kaisha, Ltd.

### (3) Formation of Cover

### (Synthesis of Polyurethane for Cover)

According to the compositional ratios shown in Table 3, the polyurethanes for the cover were synthesized as below.

Polytetramethylene ether glycol (PTMG) heated to a temperature of 80° C. was charged to dicyclohexylmethane diisocyanate (H₁₂MDI) heated to a temperature of 80° C. Further, dibutyl tin dilaurate (dibutyl tin dilaurate available from Aldrich, Inc.) was charged thereto in an amount of 0.005 mass % of the total amount of the raw materials (H₁₂MDI, PTMG and BD), and then the mixture was stirred at a temperature of 80° C. for 2 hours under a nitrogen gas flow. Subsequently, butane diol (BD) heated to a temperature of 80° C. was charged thereto under a nitrogen gas flow, and then the mixture was stirred at a temperature of 80° C. for 1 minute. Next, the reaction liquid was cooled, and degassed at room temperature for 1 minute under reduced pressure. The degassed reaction liquid was spread in a container, and stored at a temperature of 110° C. for 6 hours under a nitrogen gas atmosphere to conduct a urethane-forming reaction, thereby obtaining the polyurethanes.

TABLE 3

| Polyurethane No. | | | A | B | C | D | E |
|---|---|---|---|---|---|---|---|
| Composition | Polyol | PTMG650 | 1.00 | — | — | — | — |
| (molar ratio) | | PTMG1000 | — | 1.00 | — | — | — |
| | | PTMG1400 | — | — | 1.00 | — | — |
| | | PTMG2000 | — | — | — | 1.00 | — |
| | | PTMG3000 | — | — | — | — | 1.00 |
| | Polyisocyanate | H₁₂MDI | 2.21 | 3.07 | 3.81 | 4.50 | 4.36 |
| | Chain extender | BD | 1.21 | 2.07 | 2.81 | 3.50 | 3.36 |

PTMG 650: polytetramethylene ether glycol (number average molecular weight: 650)
PTMG 1000: polytetramethylene ether glycol (number average molecular weight: 1000)
PTMG 1400: polytetramethylene ether glycol (number average molecular weight: 1400)
PTMG 2000: polytetramethylene ether glycol (number average molecular weight: 2000)
PTMG 3000: polytetramethylene ether glycol (number average molecular weight: 3000)
H₁₂MDI: dicyclohexyl methane diisocyanate
BD: 1,4-butane diol

According to the formulations shown in Table 4, the polyurethane for the cover and titanium oxide were dry blended, and mixed with a twin-screw kneading extruder to obtain cover materials in a pellet form. The extruding conditions were a screw diameter of 45 mm, a screw rotational speed of 200 rpm, and a screw L/D=35, and the mixture was heated to 150° C. to 230° C. at the die position of the extruder. The obtained cover material in the pellet form was charged into each of the depressed part of the lower mold for molding half shells, and a pressure was applied to mold half shells. The compression molding was conducted under the conditions of a molding temperature of 170° C., a molding time of 5 minutes and a molding pressure of 2.94 MPa.

The intermediate layer-covering spherical body was concentrically covered with two of the half shells, and compression molding was conducted to mold the cover, thereby obtaining the golf ball body. The compression molding was conducted under the conditions of a molding temperature of 145° C., a molding time of 2 minutes and a molding pressure of 9.8 MPa.

TABLE 4

| Cover material No. | | 1 | 2 | 3 | 4 | 5 | 6 | 7 |
|---|---|---|---|---|---|---|---|---|
| Formulation | Polyurethane A | 100 | — | — | — | — | — | — |
| (parts by mass) | Polyurethane B | — | 100 | — | — | — | — | — |
| | Polyurethane C | — | — | 95 | 90 | 80 | 50 | — |
| | Polyurethane D | — | — | 5 | 10 | 20 | 50 | — |
| | Polyurethane E | — | — | — | — | — | — | 100 |
| | Titanium dioxide | 4 | 4 | 4 | 4 | 4 | 4 | 4 |

| | | | | | | | |
|---|---|---|---|---|---|---|---|
| Slab hardness (Shore A) | 82 | 82 | 82 | 82 | 82 | 82 | 82 |
| Loss modulus (E″₋₄₀) (×10⁷ Pa) | 11.0 | 15.8 | 9.27 | 8.73 | 8.22 | 6.87 | 3.33 |
| Loss modulus (E″₋₂₀) (×10⁷ Pa) | 10.9 | 11.6 | 4.16 | 4.51 | 4.89 | 6.24 | 3.43 |

Titanium dioxide: A-220 available from Ishihara Sangyo Kaisha, Ltd.

### (4) Formation of Paint Film

### Preparation of Urethane Polyols No. 1 to No. 4

According to the formulations shown in Table 5, a polycarbonate diol (PCD 500, PCD 800, PCD 1000) or polytetramethylene ether glycol (PTMG 650) and trimethylolpropane (TMP) were dissolved as the first polyol component in a solvent (toluene and methyl ethyl ketone). Dibutyltin dilaurate was added as a catalyst into the above prepared solution in an amount of 0.1 mass % with respect to 100 mass % of the polyol component. While keeping the temperature of the polyol solution at 80° C., isophorone diisocyanate (IPDI) was added dropwise as the first polyisocyanate component to the polyol solution and mixed. After finishing the addition of isophorone diisocyanate, stirring was continued until the isocyanate group disappeared. Then, the reaction liquid was cooled to the room temperature to prepare the urethane polyol (solid component content: 60 mass %). The composition and the like of the obtained urethane polyol are shown in Table 5.

TABLE 5

| Urethane polyol No. | | | 1 | 2 | 3 | 4 |
|---|---|---|---|---|---|---|
| Formulation | First polyol | PCD500 | 1 | — | — | — |
| (Molar ratio) | | PCD800 | — | 1 | — | — |
| | | PCD1000 | — | — | 1 | — |
| | | PTMG650 | — | — | — | 1 |
| | | TMP | 1.87 | 1.87 | 1.87 | 1.87 |
| | First | IPDI | 1.72 | 1.72 | 1.72 | 1.72 |
| | polyisocyanate | | | | | |

| | | | | |
|---|---|---|---|---|
| Amount of polycarbonate diol | 44 | 56 | 61 | — |
| in urethane polyol (mass %) | | | | |

The materials used in Table 5 are shown as follows.
PCD 500: polycarbonate diol (number average molecular weight: 500) available from Asahi Kasei Chemicals Corporation
PCD 800: polycarbonate diol (number average molecular weight: 800) available from Asahi Kasei Chemicals Corporation
PCD 1000: polycarbonate diol (number average molecular weight: 1000) available from Asahi Kasei Chemicals Corporation
PTMG 650: polyoxytetramethylene glycol (number average molecular weight: 650) available from Mitsubishi Chemical Corporation
TMP: trimethylolpropane (molecular weight: 134.2) available from Tokyo Chemical Industry Co. Ltd.
IPDI: isophorone diisocyanate (molecular weight: 222.3) available from Sumika Covestro Urethane Company, Ltd.

### Preparation of Polyol Compositions (Base Materials)

A solvent (a mixed solvent of xylene/methyl ethyl ketone=70/30 (mass ratio)) was mixed in an amount of 100 parts by mass with respect to 100 parts by mass of the resin component to prepare the polyol compositions. It is noted that dibutyltin dilaurate was added as a catalyst in an amount of 0.1 mass % with respect to 100 mass % of the resin component in the polyol composition.

### Preparation of Polyisocyanate Compositions (Curing Agent)

According to the formulations shown in Table 6, the polyisocyanates were added to prepare the polyisocyanate compositions.

As the polyisocyanate, the following materials were used.
Isocyanurate-modified product of HDI: isocyanurate-modified product of hexamethylene diisocyanate (Duranate (registered trademark) TKA-100 (NCO amount: 21.7 mass %) available from Asahi Kasei Chemicals Corporation)
Adduct-modified product of HDI: adduct-modified product of hexamethylene diisocyanate (Duranate (registered trademark) E402-80B (NCO amount: 7.3 mass %) available from Asahi Kasei Chemicals Corporation)
Biuret-modified product of HDI: biuret-modified product of hexamethylene diisocyanate (Duranate (registered trademark) 21S-75E (NCO amount: 15.5 mass %) available from Asahi Kasei Chemicals Corporation)
Isocyanurate-modified product of IPDI: isocyanurate-modified product of isophorone diisocyanate (VESTANAT (registered trademark) T1890 (NCO amount: 12.0 mass %) available from Degussa Co., Ltd.)

TABLE 6

| Paint resin No. | | | 1 | 2 | 3 | 4 |
|---|---|---|---|---|---|---|
| Formulation | Polyol | Urethane polyol No. 1 | 100 | 100 | — | — |
| | composition | Urethane polyol No. 2 | — | — | 100 | 100 |
| | (base agent) | Urethane polyol No. 3 | — | — | — | — |
| | | Urethane polyol No. 4 | — | — | — | — |
| | Polyisocyanate | Isocyanurate-modified | 20 | 30 | 30 | 50 |
| | composition | product of HDI | | | | |
| | (curing agent) | Adduct-modified product of HDI | 80 | 70 | 70 | 50 |
| | | Biuret-modified product of HDI | — | — | — | — |
| | | Isocyanurate-modified | — | — | — | — |
| | | product of IPDI | | | | |
| | Base agent/curing agent (mass | | 100/52 | 100/55 | 100/39 | 100/33 |
| | ratio of solid component) | | | | | |
| | NCO group of curing agent/OH group | | 1.2 | 1.2 | 1.2 | 1.2 |
| | of base agent (NCO/OH molar ratio) | | | | | |
| Physical | M10 (kgf/cm²) | | 20 | 60 | 29 | 81 |
| properties | M50 (kgf/cm²) | | 40 | 103 | 60 | 129 |
| | εmax (%) | | 50 | 50 | 50 | 50 |
| | ε1 (%) | | 14.3 | 34.7 | 26.0 | 35.2 |
| | ε1/M10 | | 0.72 | 0.58 | 0.90 | 0.43 |
| Paint resin No. | | | 5 | 6 | 7 | 8 |
| Formulation | Polyol | Urethane polyol No. 1 | — | — | — | — |
| | composition | Urethane polyol No. 2 | — | — | — | — |
| | (base agent) | Urethane polyol No. 3 | 100 | 100 | — | — |
| | | Urethane polyol No. 4 | — | — | 100 | 100 |
| | Polyisocyanate | Isocyanurate-modified | 30 | 50 | 30 | 30 |
| | composition | product of HDI | | | | |
| | (curing agent) | Adduct-modified product of HDI | 70 | 50 | — | — |
| | | Biuret-modified product of HDI | | | | |
| | | Isocyanurate-modified | — | — | 30 | 30 |
| | | product of IPDI | — | — | 40 | 40 |

| | | | | | |
|---|---|---|---|---|---|
| | Base agent/curing agent (mass | 100/35 | 100/32 | 100/8.7 | 100/12 |
| | ratio of solid component) | | | | |
| | NCO group of curing agent/OH group | 1.2 | 1.2 | 0.36 | 0.5 |
| | of base agent (NCO/OH molar ratio) | | | | |
| Physical | M10 (kgf/cm²) | 28 | 66 | 6 | 27 |
| properties | M50 (kgf/cm²) | 61 | 115 | 11 | 43 |
| | εmax (%) | 50 | 50 | 50 | 50 |
| | ε1 (%) | 24.5 | 32.4 | 27.1 | 32.7 |
| | ε1/M10 | 0.87 | 0.49 | 4.37 | 1.21 |

According to the formulations shown in Table 6, the polyol composition and the polyisocyanate composition were blended to prepare curing type paint compositions. The surface of the golf ball bodies obtained above was treated with sandblast and marked. Then, the paint was applied with a spray gun, and dried for 24 hours in an oven at a temperature of 40° C. to obtain golf balls having a diameter of 42.7 mm and a mass of 45.6 g. The paint film had a thickness of 10 plus or minus 2 μm.

The application of the paint was conducted as follows. The golf ball body was placed in a rotating member provided with prongs, and the rotating member was allowed to rotate at 300 rpm. The application of the paint was conducted by spacing a spray distance (7 cm) between the air gun and the golf ball body, and moving the air gun in an up and down direction. The painting interval in the overpainting operation was set to 1.0 second. The application of the paint was conducted under the spraying conditions of overpainting operation: twice, spraying air pressure: 0.15 MPa, compressed air tank pressure: 0.10 MPa, painting time per one application: one second, atmosphere temperature: 20° C. to 27° C., and atmosphere humidity: 65% or less. Evaluation results regarding the obtained golf balls are shown in Tables 7 to 9.

TABLE 7

| Golf ball No. | | | 1 | 2 | 3 | 4 | 5 |
|---|---|---|---|---|---|---|---|
| Spherical | No. | | 1 | 2 | 3 | 4 | 14 |
| core | Diameter [mm] | | 39.5 | 39.5 | 39.5 | 39.5 | 39.5 |
| | (H₅ − H₀) − (H₁₅ − H₁₀) | | 1.0 | 0.0 | 1.0 | 0.0 | 2.0 |
| | (H₁₀ − H₅) − (Hs − H₁₅) | | 1.0 | 2.0 | 0.0 | 1.0 | 0.0 |
| | [{(H₅ − H₀) + (H₁₅ − H₁₀)}/2] − | | 6.0 | 6.0 | 5.5 | 6.5 | 5.0 |
| | [{(H₁₀ − H₅) + (Hs − H₁₅)}/2] | | | | | | |
| | (H₅ + H₁₀ + H₁₅)/3 | | 72.7 | 71.7 | 70.7 | 72.0 | 72.3 |
| Intermediate | Intermediate layer composition No. | | A | A | A | A | A |
| layer | Thickness [mm] | | 1.0 | 1.0 | 1.0 | 1.0 | 1.0 |
| Cover | Cover material No. | | 4 | 4 | 4 | 4 | 4 |
| | Thickness [mm] | | 0.6 | 0.6 | 0.6 | 0.6 | 0.6 |
| | Loss modulus (E″₋₄₀) (×10⁷ Pa) | | 8.73 | 8.73 | 8.73 | 8.73 | 8.73 |
| | Loss modulus (E″₋₂₀) (×10⁷ Pa) | | 4.51 | 4.51 | 4.51 | 4.51 | 4.51 |
| Paint film | Paint resin No. | | 2 | 2 | 2 | 2 | 2 |
| | ε1/M10 | | 0.58 | 0.58 | 0.58 | 0.58 | 0.58 |
| Ball | Compression deformation amount [mm] | | 2.85 | 2.85 | 3.05 | 2.85 | 2.78 |
| Evaluation | Wear resistance of ball surface | | E | E | E | E | E |
| | Stain resistance on shots | | E | E | E | E | E |
| | from the bunker | | | | | | |
| | Approach | Spin rate (rpm) | 0 | −50 | 50 | −10 | −80 |
| | shots from | Evaluation | E | G | E | G | G |
| | the rough | | | | | | |
| | 8-Iron | Spin rate (rpm) | 0 | −100 | −50 | −60 | 0 |
| | shots | Evaluation | E | G | G | G | E |
| | Driver | Spin rate (rpm) | 0 | −50 | −50 | −20 | −30 |
| | shots | Initial velocity (m/s) | 0.0 | 0.5 | −0.2 | 0.3 | 0.2 |
| | | Flight distance (m) | 0.0 | 3.0 | −0.5 | 1.7 | 1.3 |
| | | Evaluation | E | E | G | E | E |

| | | | | | |
|---|---|---|---|---|---|
| Shot feeling on driver shots | E | E | E | E | G |
| Shot feeling on 8-Iron shots | E | E | E | E | G |
| Comprehensive evaluation | G | G | G | G | G |

| Golf ball No. | | | 6 | 7 | 8 | 9 | 10 |
|---|---|---|---|---|---|---|---|
| Spherical | No. | | 5 | 6 | 16 | 12 | 13 |
| core | Diameter [mm] | | 39.5 | 39.5 | 38.3 | 39.9 | 38.9 |
| | (H₅ − H₀) − (H₁₅ − H₁₀) | | −1.0 | −3.0 | 0.0 | 1.0 | 1.0 |
| | (H₁₀ − H₅) − (Hs − H₁₅) | | 1.0 | 2.0 | 1.0 | 1.0 | 1.0 |
| | [{(H₅ − H₀) + (H₁₅ − H₁₀)}/2] − | | 5.0 | 7.5 | 6.5 | 6.0 | 6.0 |
| | [{(H₁₀ − H₅) + (Hs − H₁₅)}/2] | | | | | | |
| | (H₅ + H₁₀ + H₁₅)/3 | | 71.7 | 67.7 | 71.0 | 72.7 | 72.7 |
| Intermediate | Intermediate layer composition No. | | A | A | B | A | B |
| layer | Thickness [mm] | | 1.0 | 1.0 | 1.6 | 0.8 | 1.3 |
| Cover | Cover material No. | | 4 | 4 | 4 | 4 | 4 |
| | Thickness [mm] | | 0.6 | 0.6 | 0.6 | 0.6 | 0.6 |
| | Loss modulus (E″₋₄₀) (×10⁷ Pa) | | 8.73 | 8.73 | 8.73 | 8.73 | 8.73 |
| | Loss modulus (E″₋₂₀) (×10⁷ Pa) | | 4.51 | 4.51 | 4.51 | 4.51 | 4.51 |
| Paint film | Paint resin No. | | 2 | 2 | 2 | 2 | 2 |
| | ε1/M10 | | 0.58 | 0.58 | 0.58 | 0.58 | 0.58 |
| Ball | Compression deformation amount [mm] | | 2.85 | 2.86 | 2.60 | 2.90 | 2.75 |
| Evaluation | Wear resistance of ball surface | | E | E | E | E | E |
| | Stain resistance on shots | | E | E | E | E | E |
| | from the bunker | | | | | | |
| | Approach | Spin rate (rpm) | 10 | −70 | −80 | 20 | 10 |
| | shots from | Evaluation | E | G | G | E | E |
| | the rough | | | | | | |
| | 8-Iron | Spin rate (rpm) | −40 | −100 | 80 | 20 | −30 |
| | shots | Evaluation | G | G | E | E | G |
| | Driver | Spin rate (rpm) | −30 | −50 | 90 | 20 | −20 |
| | shots | Initial velocity (m/s) | −0.2 | −0.1 | 0.4 | −0.1 | 0.1 |
| | | Flight distance (m) | −0.7 | 0.0 | 1.1 | −0.5 | 0.7 |
| | | Evaluation | E | E | E | G | E |

| | | | | | |
|---|---|---|---|---|---|
| Shot feeling on driver shots | E | E | G | E | G |
| Shot feeling on 8-Iron shots | E | E | G | E | G |
| Comprehensive evaluation | G | G | G | G | G |

TABLE 8

| Golf ball No. | | | 11 | 12 | 13 | 14 |
|---|---|---|---|---|---|---|
| Spherical | No. | | 1 | 1 | 1 | 1 |
| core | Diameter [mm] | | 39.5 | 39.5 | 39.5 | 39.5 |
| | (H₅ − H₀) − (H₁₅ − H₁₀) | | 1.0 | 1.0 | 1.0 | 1.0 |
| | (H₁₀ − H₅) − (Hs − H₁₅) | | 1.0 | 1.0 | 1.0 | 1.0 |
| | [{(H₅ − H₀) + (H₁₅ − H₁₀)}/2] − | | 6.0 | 6.0 | 6.0 | 6.0 |
| | [{(H₁₀ − H₅) + (Hs − H₁₅)}/2] | | | | | |
| | (H₅ + H₁₀ + H₁₅)/3 | | 72.7 | 72.7 | 72.7 | 72.7 |
| Intermediate | Intermediate layer composition No. | | A | A | A | A |
| layer | Thickness [mm] | | 1.0 | 1.0 | 1.0 | 1.0 |
| Cover | Cover material No. | | 3 | 5 | 6 | 4 |
| | Thickness [mm] | | 0.6 | 0.6 | 0.6 | 0.6 |
| | Loss modulus (E″₋₄₀) (×10⁷ Pa) | | 9.27 | 8.22 | 6.87 | 8.73 |
| | Loss modulus (E″₋₂₀) (×10⁷ Pa) | | 4.16 | 4.89 | 6.24 | 4.51 |
| Paint film | Paint resin No. | | 2 | 2 | 2 | 1 |
| | ε1/M10 | | 0.58 | 0.58 | 0.58 | 0.72 |
| Ball | Compression deformation amount [mm] | | 2.85 | 2.85 | 2.85 | 2.85 |
| Evaluation | Wear resistance of ball surface | | E | E | E | E |
| | Stain resistance on shots | | E | E | E | E |
| | from the bunker | | | | | |
| | Approach | Spin rate (rpm) | −17.5 | 17.5 | 70 | 50 |
| | shots from | Evaluation | G | E | E | E |
| | the rough | | | | | |
| | 8-Iron | Spin rate (rpm) | −35 | 36 | 140 | 0 |
| | shots | Evaluation | G | E | E | E |
| | Driver | Spin rate (rpm) | −10 | 10 | 40 | 0 |
| | shots | Initial velocity (m/s) | 0.0 | 0.0 | 0.0 | 0.0 |
| | | Flight distance (m) | 0.1 | −0.1 | −0.4 | 0.0 |
| | | Evaluation | E | G | G | E |

| | | | | |
|---|---|---|---|---|
| Shot feeling on driver shots | E | E | E | E |
| Shot feeling on 8-Iron shots | E | E | E | E |
| Comprehensive evaluation | G | G | G | G |

| Golf ball No. | | | 15 | 16 | 17 | 18 |
|---|---|---|---|---|---|---|
| Spherical | No. | | 1 | 1 | 1 | 1 |
| core | Diameter [mm] | | 39.5 | 39.5 | 39.5 | 39.5 |
| | (H₅ − H₀) − (H₁₅ − H₁₀) | | 1.0 | 1.0 | 1.0 | 1.0 |
| | (H₁₀ − H₅) − (Hs − H₁₅) | | 1.0 | 1.0 | 1.0 | 1.0 |
| | [{(H₅ − H₀) + (H₁₅ − H₁₀)}/2] − | | 6.0 | 6.0 | 6.0 | 6.0 |
| | [{(H₁₀ − H₅) + (Hs − H₁₅)}/2] | | | | | |
| | (H₅ + H₁₀ + H₁₅)/3 | | 72.7 | 72.7 | 72.7 | 72.7 |
| Intermediate | Intermediate layer composition No. | | A | A | A | A |
| layer | Thickness [mm] | | 1.0 | 1.0 | 1.0 | 1.0 |
| Cover | Cover material No. | | 4 | 4 | 4 | 4 |
| | Thickness [mm] | | 0.6 | 0.6 | 0.6 | 0.6 |
| | Loss modulus (E″₋₄₀) (×10⁷ Pa) | | 8.73 | 8.73 | 8.73 | 8.73 |
| | Loss modulus (E″₋₂₀) (×10⁷ Pa) | | 4.51 | 4.51 | 4.51 | 4.51 |
| Paint film | Paint resin No. | | 3 | 4 | 5 | 6 |
| | ε1/M10 | | 0.90 | 0.43 | 0.87 | 0.49 |
| Ball | Compression deformation amount [mm] | | 2.85 | 2.85 | 2.85 | 2.85 |
| Evaluation | Wear resistance of ball surface | | E | E | E | E |
| | Stain resistance on shots | | E | E | E | E |
| | from the bunker | | | | | |
| | Approach | Spin rate (rpm) | 40 | −10 | 30 | −20 |
| | shots from | Evaluation | E | G | E | G |
| | the rough | | | | | |
| | 8-Iron | Spin rate (rpm) | 0 | 0 | 0 | 0 |
| | shots | Evaluation | E | E | E | E |
| | Driver | Spin rate (rpm) | 0 | 0 | 0 | 0 |
| | shots | Initial velocity (m/s) | 0.0 | 0.0 | 0.0 | 0.0 |
| | | Flight distance (m) | 0.0 | 0.0 | 0.0 | 0.0 |
| | | Evaluation | E | E | E | E |

| | | | | |
|---|---|---|---|---|
| Shot feeling on driver shots | E | E | E | E |
| Shot feeling on 8-Iron shots | E | E | E | E |
| Comprehensive evaluation | G | G | G | G |

TABLE 9

| Golf ball No. | | | 19 | 20 | 21 | 22 | 23 | 24 |
|---|---|---|---|---|---|---|---|---|
| Spherical | No. | | 15 | 7 | 8 | 9 | 10 | 11 |
| core | Diameter [mm] | | 39.5 | 39.5 | 39.5 | 39.5 | 39.5 | 39.5 |
| | (H₅ − H₀) − (H₁₅ − H₁₀) | | 4.0 | 4.0 | 0.0 | 1.0 | 4.0 | 0.0 |
| | (H₁₀ − H₅) − (Hs − H₁₅) | | −1.0 | −6.0 | 5.0 | −3.0 | −1.0 | 2.0 |
| | [{(H₅ − H₀) + (H₁₅ − H₁₀)}/2] − | | 6.5 | 3.0 | 5.5 | 4.0 | 3.5 | 6.0 |
| | [{(H₁₀ − H₅) + (Hs − H₁₅)}/2] | | | | | | | |
| | (H₅ + H₁₀ + H₁₅)/3 | | 72.7 | 71.3 | 70.0 | 69.7 | 72.7 | 73.7 |
| Intermediate | Intermediate layer composition No. | | A | A | A | A | A | A |
| layer | Thickness [mm] | | 1.0 | 1.0 | 1.0 | 1.0 | 1.0 | 1.0 |
| Cover | Cover material No. | | 4 | 4 | 4 | 4 | 4 | 4 |
| | Thickness [mm] | | 0.6 | 0.6 | 0.6 | 0.6 | 0.6 | 0.6 |
| | Loss modulus (E″₋₄₀) (×10⁷ Pa) | | 8.73 | 8.73 | 8.73 | 8.73 | 8.73 | 8.73 |
| | Loss modulus (E″₋₂₀) (×10⁷ Pa) | | 4.51 | 4.51 | 4.51 | 4.51 | 4.51 | 4.51 |
| Paint film | Paint resin No. | | 2 | 2 | 2 | 2 | 2 | 2 |
| | ε1/M10 | | 0.58 | 0.58 | 0.58 | 0.58 | 0.58 | 0.58 |
| Ball | Compression deformation | | 3.00 | 2.75 | 2.72 | 2.85 | 2.85 | 2.45 |
| | amount [mm] | | | | | | | |
| Evaluation | Wear resistance of ball surface | | E | E | E | E | E | E |
| | Stain resistance on shots | | E | E | E | E | E | E |
| | from the bunker | | | | | | | |
| | Approach | Spin rate (rpm) | −60 | 50 | −85 | −100 | −80 | −80 |
| | shots from | Evaluation | G | E | G | F | G | G |
| | the rough | | | | | | | |
| | 8-Iron | Spin rate (rpm) | −220 | 150 | −150 | −70 | −100 | 175 |
| | shots | Evaluation | F | E | F | G | G | E |
| | Driver | Spin rate (rpm) | −100 | 200 | −100 | −50 | −30 | 40 |
| | shots | Initial velocity (m/s) | −0.2 | 0.2 | −0.2 | 0.1 | −0.3 | 0.4 |
| | | Flight distance (m) | 0.0 | −1.0 | 0.0 | 1.0 | −1.2 | 1.4 |
| | | Evaluation | E | F | E | E | P | E |

| | | | | | | |
|---|---|---|---|---|---|---|
| Shot feeling on driver shots | E | G | G | E | E | F |
| Shot feeling on 8-Iron shots | E | G | G | E | E | F |
| Comprehensive evaluation | F | F | F | F | P | F |

| Golf ball No. | | | 25 | 26 | 27 | 28 | 29 |
|---|---|---|---|---|---|---|---|
| Spherical | No. | | 1 | 1 | 1 | 1 | 1 |
| core | Diameter [mm] | | 39.5 | 39.5 | 39.5 | 39.5 | 39.5 |
| | (H₅ − H₀) − (H₁₅ − H₁₀) | | 1.0 | 1.0 | 1.0 | 1.0 | 1.0 |
| | (H₁₀ − H₅) − (Hs − H₁₅) | | 1.0 | 1.0 | 1.0 | 1.0 | 1.0 |
| | [{(H₅ − H₀) + (H₁₅ − H₁₀)}/2] − | | 6.0 | 6.0 | 6.0 | 6.0 | 6.0 |
| | [{(H₁₀ − H₅) + (Hs − H₁₅)}/2] | | | | | | |
| | (H₅ + H₁₀ + H₁₅)/3 | | 72.7 | 72.7 | 72.7 | 72.7 | 72.7 |
| Intermediate | Intermediate layer composition No. | | A | A | A | A | A |
| layer | Thickness [mm] | | 1.0 | 1.0 | 1.0 | 1.0 | 1.0 |
| Cover | Cover material No. | | 1 | 2 | 7 | 4 | 4 |
| | Thickness [mm] | | 0.6 | 0.6 | 0.6 | 0.6 | 0.6 |
| | Loss modulus (E″₋₄₀) (×10⁷ Pa) | | 11.0 | 15.8 | 3.33 | 8.73 | 8.73 |
| | Loss modulus (E″₋₂₀) (×10⁷ Pa) | | 10.9 | 11.6 | 3.43 | 4.51 | 4.51 |
| Paint film | Paint resin No. | | 2 | 2 | 2 | 7 | 8 |
| | ε1/M10 | | 0.58 | 0.58 | 0.58 | 4.37 | 1.21 |
| Ball | Compression deformation amount [mm] | | 2.85 | 2.85 | 2.85 | 2.85 | 2.85 |
| Evaluation | Wear resistance of ball surface | | E | E | E | E | F |
| | Stain resistance on shots | | E | E | E | F | E |
| | from the bunker | | | | | | |
| | Approach | Spin rate (rpm) | −495 | −300 | 383 | 10 | −70 |
| | shots from | Evaluation | P | P | E | E | G |
| | the rough | | | | | | |
| | 8-Iron | Spin rate (rpm) | −990 | −600 | 765 | 0 | 0 |
| | shots | Evaluation | P | P | E | E | E |
| | Driver | Spin rate (rpm) | −125 | −30 | 200 | 0 | 0 |
| | shots | Initial velocity (m/s) | 0.0 | 0.0 | 0.0 | 0.0 | 0.0 |
| | | Flight distance (m) | 1.3 | 0.3 | −2.0 | 0.0 | 0.0 |
| | | Evaluation | E | E | P | E | E |

| | | | | | |
|---|---|---|---|---|---|
| Shot feeling on driver shots | E | E | E | E | E |
| Shot feeling on 8-Iron shots | E | E | E | E | E |
| Comprehensive evaluation | P | P | P | F | F |

The golf balls No. 1 to 18 are cases that the spherical core has the predetermined hardness distribution, the cover is formed from a material having a loss modulus (E″₋₄₀) in a range from 6.50×10⁷ Pa to 22.0×10⁷ Pa and a loss modulus (E″₋₂₀) in a range from 3.50×10⁷ Pa to 7.10×10⁷ Pa, and the paint film is formed from a resin satisfying a relationship of 0.10≤ε1/M10≤1.00 wherein M10 (kgf/cm²) is a stress at which a strain is 10%, and ε1(%) is a strain at which a stress during decrease in the deformation is 0 kgf/cm².

These golf balls No. 1 to 18 have an improved surface wear resistance and an improved stain resistance on bunker shots, and have an improved shot feeling on long shots as well as a well-balanced total performance of a spin performance on approach shots and middle iron shots and a flight distance performance on driver shots.

The golf balls No. 19 to 23 are cases that the hardness distribution of the spherical core doesn't satisfy one of the formulae (1) to (3).

The golf balls No. 25 to 27 are cases that the cover material has a loss modulus (E″₋₂₀) of less than 3.50×10⁷ Pa or more than 7.10×10⁷ Pa.

These golf balls No. 19 to 23 and 25 to 27 have a poorly balanced total performance of a spin performance on approach shots, a spin performance on middle iron shots and a flight distance performance on driver shots.

The golf ball No. 24 is a case that the hardness distribution of the spherical core doesn't satisfy the formula (4).

The shot feeling of the golf ball No. 24 on long shots is not improved.

The golf balls No. 28 and 29 are cases that the paint film resin has ε1/M10 of more than 1.00. The wear resistance of a golf ball surface or the stain resistance on bunker shots of these golf balls No. 28 and 29 are not improved.

The present disclosure (1) is a golf ball comprising a golf ball body composed of a spherical core and a cover covering the spherical core, and a paint film formed on a surface of the golf ball body, wherein
a center hardness (H₀) of the spherical core, a hardness (H₅) at a point having a radial distance of 5.0 mm from a center of the spherical core, a hardness (H₁₀) at a point having a radial distance of 10 mm from the center of the spherical core, a hardness (H₁₅) at a point having a radial distance of 15 mm from the center of the spherical core, and a surface hardness (Hs) of the spherical core in Shore C hardness satisfy relationships of the following formulae (1) to (4):

$$- 3. \leq \{ ( {H}_{5} - {H}_{0} ) - ( {H}_{15} - {H}_{10} ) \} \leq 3. , \qquad ( 1 )$$

$$- 3. \leq \{ ( {H}_{10} - {H}_{5} ) - ( {H}_{s} - {H}_{15} ) \} \leq 3. , \qquad ( 2 )$$

$$5. \leq [ \{ ( {H}_{5} - {H}_{0} ) + ( {H}_{15} - {H}_{10} ) \} / 2 - \{ ( {H}_{10} - {H}_{5} ) + ( Hs - {H}_{15} ) \} / 2 ] \leq 10. , \qquad ( 3 )$$

$$65 \leq \{ ( {H}_{5} + {H}_{10} + {H}_{15} ) / 3 \} \leq 73 , \qquad ( 4 )$$

the cover is formed from a cover material having a loss modulus (E″₋₄₀) in a range from 6.50×10⁷ Pa to 22.0×10⁷ Pa at a measuring temperature of −40° C., and a loss modulus (E″₋₂₀) in a range from 3.50×10⁷ Pa to 7.10×10⁷ Pa at a measuring temperature of −20° C., measured with a dynamic viscoelasticity measurement apparatus under the following measuring conditions:
<measuring conditions of dynamic viscoelasticity measurement apparatus>
measuring mode: tensile mode
measuring temperature: −100° C. to 100° C.
temperature rising rate: 4° C./min
oscillation frequency: 10 Hz
measuring strain: 0.05%,
the paint film is formed from a paint resin satisfying a relationship of 0.10≤ε1/M10≤1.00, wherein a test piece formed from the paint resin is deformed until a strain of the test piece becomes a predetermined value max and then the deformation of the test piece is decreased until a stress of the test piece becomes 0 kgf/cm² in a tensile test, and M10 (kgf/cm²) is a stress at which a strain of the test piece is 10% during increase in the deformation, and E1(%) is a strain at which a stress of the test piece is 0 kgf/cm² during decrease in the deformation:
<test conditions of tensile test>
dimension of test piece: width of 4 mm and thickness of 100 μm plus or minus 10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%).

The present disclosure (2) is the golf ball according to the present disclosure (1), wherein the center hardness (H₀), the hardness (H₅), the hardness (H₁₀) and the hardness (H₁₅) in Shore C hardness satisfy a relationship of the following formula (5):

$$[ \{ ( {H}_{5} - {H}_{0} ) + ( {H}_{15} - {H}_{10} ) \} / 2 ] \geq 6. . \qquad ( 5 )$$

The present disclosure (3) is the golf ball according to the present disclosure (1) or (2), wherein the hardness (H₅), the hardness (H₁₀), the hardness (H₁₅) and the surface hardness (Hs) in Shore C hardness satisfy a relationship of the following formula (6):

$$[ \{ ( {H}_{10} - {H}_{5} ) + ( Hs - {H}_{15} ) \} / 2 ] \leq 2. . \qquad ( 6 )$$

The present disclosure (4) is the golf ball according to any one of the present disclosures (1) to (3), wherein the center hardness (H₀) and the surface hardness (Hs) in Shore C hardness satisfy a relationship of the following formula (7):

$$( Hs - {H}_{0} ) \geq 18. . \qquad ( 7 )$$

The present disclosure (5) is the golf ball according to any one of the present disclosures (1) to (4), wherein the center hardness (H₀) is 57.0 or more in Shore C hardness.

The present disclosure (6) is the golf ball according to any one of the present disclosures (1) to (5), wherein the golf ball has a compression deformation amount of 2.70 mm or more when being applied a load from an initial load of 98 N to a final load of 1275 N.

The present disclosure (7) is the golf ball according to any one of the present disclosures (1) to (6), wherein the cover material contains, as a resin component, a polyurethane for the cover obtained by a reaction between a polyol and a polyisocyanate, and the polyol constituting the polyurethane for the cover includes at least one polymer polyol selected from the group consisting of a polyether polyol, a condensed polyester polyol, a lactone polyester polyol, a polycarbonate polyol and an acrylic polyol.

The present disclosure (8) is the golf ball according to the present disclosure (7), wherein the polyol constituting the polyurethane for the cover includes a first polymer polyol and a second polymer polyol having a number average molecular weight greater than the first polymer polyol.

The present disclosure (9) is the golf ball according to the present disclosure (7) or (8), wherein an amount of the polyether polyol is 50 mass % or more in 100 mass % of the polyol constituting the polyurethane for the cover.

The present disclosure (10) is the golf ball according to any one of the present disclosures (1) to (9), wherein the paint resin contains a polyurethane for the paint as a resin component.

The present disclosure (11) is the golf ball according to the present disclosure (10), wherein a polyol component constituting the polyurethane for the paint includes at least one member selected from the group consisting of a polyether diol, a polyester diol, a polycaprolactone diol and a polycarbonate diol.

The present disclosure (12) is the golf ball according to the present disclosure (10) or (11), wherein the polyol component constituting the polyurethane for the paint includes the polycarbonate diol.

The present disclosure (13) is the golf ball according to any one of the present disclosures (10) to (12), wherein a polyisocyanate component constituting the polyurethane for the paint includes at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate.

The present disclosure (14) is the golf ball according to any one of the present disclosures (10) to (13), wherein a polyisocyanate component constituting the polyurethane for the paint includes hexamethylene diisocyanate.

The present disclosure (15) is the golf ball according to any one of the present disclosures (10) to (14), wherein a polyisocyanate component constituting the polyurethane for the paint includes an isocyanurate-modified product of hexamethylene diisocyanate and an adduct-modified product of hexamethylene diisocyanate.

This application is based on Japanese patent application No. 2024-095964 filed on Jun. 13, 2024, the content of which is hereby incorporated by reference.

1. A golf ball comprising a golf ball body composed of a spherical core and a cover covering the spherical core, and a paint film formed on a surface of the golf ball body, wherein
a center hardness (H₀) of the spherical core, a hardness (H₅) at a point having a radial distance of 5.0 mm from a center of the spherical core, a hardness (H₁₀) at a point having a radial distance of 10 mm from the center of the spherical core, a hardness (H₁₅) at a point having a radial distance of 15 mm from the center of the spherical core, and a surface hardness (Hs) of the spherical core in Shore C hardness satisfy relationships of the following formulae (1) to (4):
$$- 3. \leq \{ ( {H}_{5} - {H}_{0} ) - ( {H}_{15} - {H}_{10} ) \} \leq 3. , \qquad ( 1 )$$
$$- 3. \leq \{ ( {H}_{10} - {H}_{5} ) - ( {H}_{s} - {H}_{15} ) \} \leq 3. , \qquad ( 2 )$$
$$5. \leq [ \{ ( {H}_{5} - {H}_{0} ) + ( {H}_{15} - {H}_{10} ) \} / 2 - \{ ( {H}_{10} - {H}_{5} ) + ( Hs - {H}_{15} ) \} / 2 ] \leq 10. , \qquad ( 3 )$$
$$65 \leq \{ ( {H}_{5} + {H}_{10} + {H}_{15} ) / 3 \} \leq 73 , \qquad ( 4 )$$
the cover is formed from a cover material having a loss modulus (E″₋₄₀) in a range from 6.50×10⁷ Pa to 22.0×10⁷ Pa at a measuring temperature of −40° C., and a loss modulus (E″₋₂₀) in a range from 3.50×10⁷ Pa to 7.10×10⁷ Pa at a measuring temperature of −20° C., measured with a dynamic viscoelasticity measurement apparatus under the following measuring conditions:
<measuring conditions of dynamic viscoelasticity measurement apparatus>
measuring mode: tensile mode
measuring temperature: −100° C. to 100° C.
temperature rising rate: 4° C./min
oscillation frequency: 10 Hz
measuring strain: 0.05%,
the paint film is formed from a paint resin satisfying a relationship of 0.10≤ε1/M10≤1.00, wherein a test piece formed from the paint resin is deformed until a strain of the test piece becomes a predetermined value εmax and then the deformation of the test piece is decreased until a stress of the test piece becomes 0 kgf/cm² in a tensile test, and M10 (kgf/cm²) is a stress at which a strain of the test piece is 10% during increase in the deformation, and ε1(%) is a strain at which a stress of the test piece is 0 kgf/cm² during decrease in the deformation:
<test conditions of tensile test>
dimension of test piece: width of 4 mm and thickness of 100 μm±10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%).

2. The golf ball according to claim 1, wherein the center hardness (H₀), the hardness (H₅), the hardness (H₁₀) and the hardness (H₁₅) in Shore C hardness satisfy a relationship of the following formula (5):
$$[ \{ ( {H}_{5} - {H}_{0} ) + ( {H}_{15} - {H}_{10} ) \} / 2 ] \geq 6. . \qquad ( 5 )$$

3. The golf ball according to claim 1, wherein the hardness (H₅), the hardness (H₁₀), the hardness (H₁₅) and the surface hardness (Hs) in Shore C hardness satisfy a relationship of the following formula (6):
$$[ \{ ( {H}_{10} - {H}_{5} ) + ( Hs - {H}_{15} ) \} / 2 ] \leq 2. . \qquad ( 6 )$$

4. The golf ball according to claim 1, wherein the center hardness (H₀) and the surface hardness (Hs) in Shore C hardness satisfy a relationship of the following formula (7):
$$( Hs - {H}_{0} ) \geq 18. . \qquad ( 7 )$$

5. The golf ball according to claim 1, wherein the center hardness (H₀) is 57.0 or more in Shore C hardness.

6. The golf ball according to claim 1, wherein the golf ball has a compression deformation amount of 2.70 mm or more when applying a load from an initial load of 98 N to a final load of 1275 N.

7. The golf ball according to claim 1, wherein the cover material contains, as a resin component, a polyurethane for the cover obtained by a reaction between a polyol and a polyisocyanate, and
the polyol constituting the polyurethane for the cover includes at least one polymer polyol selected from the group consisting of a polyether polyol, a condensed polyester polyol, a lactone polyester polyol, a polycarbonate polyol and an acrylic polyol.

8. The golf ball according to claim 7, wherein the polyol constituting the polyurethane for the cover includes a first polymer polyol and a second polymer polyol having a number average molecular weight greater than the first polymer polyol.

9. The golf ball according to claim 7, wherein an amount of the polyether polyol is 50 mass % or more in 100 mass % of the polyol constituting the polyurethane for the cover.

10. The golf ball according to claim 1, wherein the paint resin contains a polyurethane for the paint as a resin component.

11. The golf ball according to claim 10, wherein a polyol component constituting the polyurethane for the paint includes at least one member selected from the group consisting of a polyether diol, a polyester diol, a polycaprolactone diol and a polycarbonate diol.

12. The golf ball according to claim 11, wherein the polyol component constituting the polyurethane for the paint includes the polycarbonate diol.

13. The golf ball according to claim 10, wherein a polyisocyanate component constituting the polyurethane for the paint includes at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate.

14. The golf ball according to claim 10, wherein a polyisocyanate component constituting the polyurethane for the paint includes hexamethylene diisocyanate.

15. The golf ball according to claim 10, wherein a polyisocyanate component constituting the polyurethane for the paint includes an isocyanurate-modified product of hexamethylene diisocyanate and an adduct-modified product of hexamethylene diisocyanate.

16. The golf ball according to claim 1, wherein the hardness (H₀), the hardness (H₅), the hardness (H₁₀), the hardness (H₁₅) and the hardness (Hs) satisfy a relationship of the following formula (8):
$${H}_{0} < {H}_{5} < {H}_{10} < {H}_{15} < Hs . \qquad ( 8 )$$

17. The golf ball according to claim 1, wherein the cover material has a slab hardness in a range from 65 to 95 in Shore A hardness.

18. The golf ball according to claim 1, wherein the golf ball body comprises an intermediate layer between the spherical core and the cover.
